(19) United States
(12) Patent Application Publication
(10) Pub. No.: US 2017/0333877 A1
(43) Pub. Date: Nov. 23, 2017

(54) MIXED METAL OXIDE COMPOSITE FOR OXYGEN STORAGE

(71) Applicant: BASF SE, Ludwigshafen (DE)

(72) Inventors: Sven TITLBACH, Heidelberg (DE); Stephan A. SCHUNK, Heidelberg-Rohrbach (DE); Robert MUELLER, Nussloch (DE); Andreas SUNDERMANN, Bensheim (DE); Michael GOEBEL, Neustadt (Weinstr.) (DE); Andrey KARPOV, Speyer (DE); Michel DEEBA, East Brunswick, NJ (US); Xiaolai ZHENG, Princeton Junction, NJ (US); Robert GLAUM, Rheinbach-Flerzheim (DE); Andreas SCHMITZ, Wachtberg (DE)

(73) Assignee: BASF SE, Ludwigshafen (DE)

(21) Appl. No.: 15/524,893

(22) PCT Filed: Nov. 5, 2015
(86) PCT No.: PCT/EP2015/075821

§ 371 Date: May 5, 2017

Related U.S. Application Data
(60) Provisional application No. 62/075,915, filed on Nov. 6, 2014.

(51) Int. Cl. B01J 23/10; B01D 53/94; B01J 37/06; B01J 37/08; B01J 37/02; B01J 37/03

(52) U.S. Cl. CPC B01J 23/10; B01J 37/0201; B01J 37/0236; B01J 37/031; B01J 37/06; B01J 37/08; B01D 53/945; B01D 2255/2065; B01D 2255/2066; B01D 2255/2092; B01D 2255/40; B01D 2255/908; B01D 2255/9207

(57) ABSTRACT

The present invention relates to a composite oxide comprising ceria, praseodymia and alumina, wherein the cerium:praseodymium molar ratio of the composite oxide is 84:16 or less, as well as to a method of preparing the composite oxide and to its use, in particular in a method of treating an exhaust gas stream.

The present invention relates to a composite oxide comprising ceria, praseodymia and alumina employing specific ratios of cerium:praseodymium as well as to methods for the production of such composite oxides. Furthermore, the present invention relates to the use of the inventive oxides as well as composite oxides which are obtained and/or obtainable by the inventive method in catalysis, and in particular as an oxygen storage material in the treatment of exhaust gas, as well as to a method of treating an exhaust gas stream employing the aforementioned inventive materials.

### INTRODUCTION

Three-way conversion (TWC) catalysts are used in engine exhaust streams to catalyze the oxidation of the unburned hydrocarbons (HCs) and carbon monoxide (CO) and the reduction of nitrogen oxides (NOₓ) to nitrogen. The presence of an oxygen storage component (OSC) in a TWC catalyst allows oxygen to be stored during (fuel) lean conditions to promote reduction of NOₓ adsorbed on the catalyst, and to be released during (fuel) rich conditions to promote oxidation of HCs and CO adsorbed on the catalyst. TWC catalysts typically comprise one or more platinum group metals (e.g., platinum, palladium, rhodium, and/or iridium) located upon a support such as a high surface area, refractory oxide support, e.g., a high surface area alumina or a composite support such as a ceria-zirconia composite. The ceria-zirconia composite can also provide oxygen storage capacity. The support is carried on a suitable carrier or substrate such as a monolithic carrier comprising a refractory ceramic or metal honeycomb structure, or refractory particles such as spheres or short, extruded segments of a suitable refractory material.

OSC materials based on cerium praseodymium mixed oxides have been described in a number of publications (e.g. in Logan et al., J. Mater. Res. 1994, 9, 468; Narula et al., J. Phys. Chem. B 1999, 103, 3634; Chun et al., Catal. Lett. 2006, 106, 95). Pure (undoped) cerium praseodymium oxides suffer from their low thermal durability reflected by low surface area after exposure to high temperature treatment. Logan et al. in J. Mater. Res. 1994, 9, 468, provide a BET surface area for a cerium praseodymium mixed oxide with a ceria content of 45.5 mol% of 13.3 m²/g after material calcination at 750° C. for 2h. Even lower surface area of 2.4 m²/g has been observed for a cerium praseodymium mixed oxide with a ceria content of 17.3 mol % in the same publication. Luo et al. in Journal of Molecular Catalysis A: Chemical 260 (2006), 157-162 concerns CeₓPr₁₋ₓO_{2-delta} mixed oxides and their catalytic activities for CO, methanol, and methane combustion. EP 1 127 605 B1 concerns a method of manufacturing an exhaust gas catalyst by providing a cerium-praseodymium mixed oxide and mixing the same with gamma-alumina for washcoating onto a monolithic substrate.

In conventional approaches, materials suffering from low surface area are brought onto a support. Thus in Lopez-Haro et al., Chem. Mater. 2009, 21, 1035, and in Blanco et al., Catal. Today 2012, 180, 184, cerium-praseodymium mixed oxide with a cerium:praseodymium molar ratio of 4:1 has been deposited onto two modified alumina supports (lanthanum oxide or silica modified alumina) by incipient wetness impregnation using an aqueous solution containing a mixture of cerium and praseodymium nitrates. The cerium-praseodymium mixed oxide was loaded onto alumina at a weight content of 25%. However, a significant deterioration of OSC functionality was observed when the materials were exposed to high temperature treatment at 900° C. (cf. Lopez-Haro et al., Chem. Mater. 2009, 21, 1035, wherein OSC values dropped by 30% for cerium-praseodymium mixed oxide deposited on silica modified alumina and OSC value went to a null value for cerium-praseodymium mixed oxide deposited on lanthanum oxide modified alumina).

Shigapov et al. in Studies in Surface Science and Catalysis 130, 2000, 1373-1378 relates to PrO₂—CeO₂-based mixed oxides and their use in automotive-exhaust catalysis, wherein the materials are stabilized with low levels of zirconium, yttrium, or calcium.

In order to avoid interaction problems between praseodymium oxide and alumina caused by low temperature formation of aluminate phase by reaction between praseodymium oxide and alumina U.S. Pat. No. 6,423,293 proposes a mixed oxide OSC material based on praseodymium oxide loaded onto an alumina free support of either cerium oxide or cerium-zirconium oxide.

In other conventional approaches, materials suffering from low surface area can be stabilized by dopants improving the thermal durability of the materials. Thus, U.S. Pat. No. 6,893,998 and U.S. Pat. No. 7,229,948 describe the use of an oxide solid solution based on praseodymium and cerium doped with 0-10 weight % zirconium and 0-10 weight % yttrium. The oxide mixture can be loaded with 0-2 weight % palladium, platinum or rhodium. The oxide mixture based on cerium-praseodymium-zirconium oxide could be further mixed with a binder such as gamma aluminum at a gamma alumina:oxide mixture molar ratio about 0.1:1 to 1:1.

US 2011/0064639 A1 relates to a composite oxide containing at least one of Ce, Pr, and Zr at a particular ratio, and optionally a further metal M, wherein experimental section includes a Pr—Zr composite oxide containing Al. WO 2013/092557 A1 relates to a composite oxide comprising cerium and at least one element selected from the group consisting of yttrium, zirconium, silicon and rare earth elements other than cerium as well as 1-20 mass % of aluminum in terms of the oxide, as well as to its use in exhaust gas purification. In the experimental section of said document, a composite oxide of cerium, praseodymium, barium, and aluminum at a mass ratio of 85:5:5:5 is described.

There is a continuing need in the art for catalytic materials that are thermally stable and yet display a high oxygen storage capacity, in particular under their conditions of use such as in exhaust gas treatment.

### DETAILED DESCRIPTION

It is therefore an object of the present invention to provide an improved oxygen storage material, in particular for use as an oxygen storage component in the treatment of exhaust gas, as well as to a method for its production. Furthermore, it is an object of the present invention to provide an improved method for the treatment of exhaust gases, in particular by using improved oxygen storage materials.

Thus, it has surprisingly been found that the specific catalyst composites of the present invention containing a ceria-paraseodymia mixed oxide in addition to alumina display superior catalytic properties in particular when used as an oxygen storage material compared to oxygen storage materials known in the art, in particular after having been exposed to aging conditions ensuing from prolonged use such as those encountered in the treatment of automotive exhaust gas.

Therefore, the present invention relates to a composite oxide comprising ceria, praseodymia, and alumina, wherein the cerium:praseodymium molar ratio of the composite oxide is 84:16 or less.

According to the present invention, no particular restriction applies relative to the cerium:praseodymium molar ratio of the composite oxide, provided that it is 84:16 or less. Thus, by way of examples, the cerium:praseodymium molar ratio of the inventive composite oxide may be comprised in the range of anywhere from 15:85 to 80:20, wherein preferably the molar ratio is comprised in the range of from 25:75 to 75:25, more preferably from 35:65 to 70:30, more preferably from 40:60 to 65:35, more preferably from 42.5:57.5 to 62.5:37.5, more preferably from 45:55 to 60:40, and more preferably of from 47.5:52.5 to 57.5:42.5. According to the present invention it is particularly preferred that the cerium:praseodymium molar ratio of the inventive composite oxide is in the range of from 50:50 to 55:45.

As regards the term “composite oxide” as employed in the present invention, said term designates a solid solution of the metal oxides contained therein. According to a preferred definition of the present invention, the term “composite oxide” refers to a solid solution of the metal oxides contained therein as obtained and/or obtainable according to a co-precipitation procedure of one or more sources of the individual metal oxides, respectively.

As regards the molar ratio of cerium:praseodymium in the composite oxide according to the present invention, no particular restriction applies provided that said molar ratio is 84:16 or less. Thus, by way of example, the cerium:praseodymium molar ratio may be comprised in the range of anywhere from 15:85 to 80:20, wherein preferably, the molar ratio of cerium:praseodymium in the composite oxide comprising ceria, praseodymia and alumina is comprised in the range of from 25:75 to 75:25, and more preferably in the range of from 35:65 to 70:30, more preferably from 40:60 to 65:35, more preferably from 42.5:57.5 to 62.5:37.5, more preferably from 45:55 to 60:40, and more preferably from 47.5:52.5 to 57.5:42.5. According to the present invention it is particularly preferred that the molar ratio of cerium:praseodymium in the composite oxide is comprised in the range of from 50:50 to 55:45.

According to the present invention, the term “composite oxide” defines an oxide comprising ceria, praseodymia, and alumina, wherein it is not excluded that the composite oxide may further comprise one or more metal oxides and/or metalloid oxides and/or non-metal oxides. Furthermore, unless stated otherwise, the terms “cerium”, “praseodymium”, and “aluminum” refer to cerium, parseodymium, and aluminum contained in the ceria, praseodymia, and alumina respectively contained in the composite oxide. Consequently, the cerium:praseodymium molar ratio of the composite oxide refers to the molar ratio of cerium to praseodymium respectively contained as ceria and praseodymia in the composite oxide, i.e. wherein ceria and praseodymia are contained in the composite oxide in an amount such that the cerium:praseodymium molar ratio based on the total amount of ceria and praseodymia respectively contained in the composite oxide is 84:16 or less, and preferably comprised in the range of from 15:85 to 80:20, more preferably from 25:75 to 75:25, more preferably from 35:65 to 70:30, more preferably from 40:60 to 65:35, more preferably from 42.5:57.5 to 62.5:37.5, more preferably from 45:55 to 60:40, more preferably from 47.5: 52.5 to 57.5:42.5, more preferably from 50:50 to 55:45.

As regards the content of cerium in the composite oxide of the present invention, no particular restriction applies such that in principle any conceivable amount of cerium may be contained therein provided that the cerium:praseodymium molar ratio of the composite oxide is 84:16 or less. Thus, by way of example, the content of cerium in the composite oxide may range anywhere from 15 to 80 mol.-% based on 100 mol.-% of the total moles of cerium, praseodymium, and aluminum in the composite oxide, wherein preferably the content of cerium is comprised in the range of from 20 to 75 mol.-%, and more preferably of from 25 to 70 mol.-%, more preferably from 30 to 65 mol.-%, more preferably from 35 to 60 mol.-%, more preferably from 40 to 55 mol.-%, and more preferably of from 42.5 to 52.5 mol.-%. According to the present invention it is particularly preferred that the content of cerium in the composite oxide is in the range of from 45 to 50 mol.-% based on 100 mol.-% of the total moles of cerium, praseodymium, and aluminum in the composite oxide.

Furthermore, as regards the content of praseodymium in the composite oxide of the present invention, no particular restriction applies such that in principle any conceivable amount of praseodymium may be contained therein provided that the cerium : praseodymium molar ratio of the composite oxide is 84:16 or less. Thus, by way of example, the content of praseodymium in the composite oxide may range anywhere from 15 to 80 mol.-% based on 100 mol.-% of the total moles of cerium, praseodymium, and aluminum in the composite oxide, wherein preferably the content of praseodymium is comprised in the range of from 20 to 75 mol.-%, and more preferably of from 25 to 70 mol.-%, more preferably from 30 to 60 mol.-%, more preferably from 32.5 to 55 mol.-%, more preferably from 35 to 50 mol.-%, and more preferably of from 37.5 to 47.5 mol.-%. According to the present invention it is particularly preferred that the content of praseodymium in the composite oxide is in the range of from 40 to 45 mol.-% based on 100 mol.-% of the total moles of cerium, praseodymium, and aluminum in the composite oxide.

Concerning the content of aluminum in the composite oxide of the present invention, no particular restriction applies such that in principle any conceivable amount of aluminum may be contained therein. Thus, by way of example, the content of aluminum in the composite oxide may range anywhere from 0.2 to 70 mol.-% based on 100 mol.-% of the total moles of cerium, praseodymium, and aluminum in the composite oxide, wherein preferably the content of aluminum is comprised in the range of from 0.5 to 55 mol.-%, and more preferably of from 1.0 to 45 mol.-%, more preferably from 1.5 to 35 mol.-%, more preferably from 2 to 30 mol.-%, more preferably from 2.5 to 25 mol.-%, more preferably from 3 to 20 mol.-%, more preferably from 3.5 to 15 mol.-%, more preferably from 4 to 12 mol.-%, and more preferably from 4.5 to 11 mol.-%. According to the present invention it is particularly preferred that the content of aluminum in the composite oxide is in the range of from 5 to 10 mol.-% based on 100 mol.-% of the total moles of cerium, praseodymium, and aluminum in the composite oxide.

As noted above, the composite oxide of the present invention may contain one or more further metal oxides other than ceria, praseodymia, and alumina, and/or one or more metalloid oxides, and/or one or more non-metal oxides, wherein preferably the composite oxide according to the present invention comprises one or more further oxides selected among metal oxides and metalloid oxides, wherein more preferably the composite oxide comprises one or more further metal oxides other than ceria, praseodymia, and alumina. There is no particular restriction whatsoever as to the one or more metal oxides which may be further comprised in the composite oxide besides ceria, praseodymia, and alumina. According to the present invention it is however preferred that the composite oxide comprising ceria, praseodymia, and alumina further comprises one or more rare earth oxides other than ceria and praseodymia and/or further comprises zirconia. As regards the one or more rare earth oxides other than ceria and praseodymia which are preferably comprised in the composite oxide, no particular restriction applies such that any one or more further rare earth oxides other than ceria and praseodymia may be contained therein, wherein preferably the one or more rare earth oxides other than ceria and praseodymia are selected from the group consisting of lanthana, neodymia, samaria, gadolinia, terbia, yttria, and combinations of two or more thereof, and more preferably from the group consisting of lanthana, neodymia, yttria, and combinations of two or more thereof. According to the present invention it is particularly preferred that the composite oxide comprising ceria, praseodymia, and alumina further comprises yttria and/or neodymia, and more preferably further comprises yttria.

Within the meaning of the present invention, the term “rare earth oxide” refers to the oxides of the rare earth metals as defined by IUPAC and more specifically of the oxides of the lanthanides, of scandium, and of yttrium, i.e. of the rare earth metals La, Ce, Pr, Nd, Pm, Sm, Eu, Gd, Tb, Dy, Ho, Er, Tm, Yb, Lu, Sc, and Y. Furthermore, unless otherwise specified, the designation of the rare earth oxides does not refer to a particular type thereof, in particular relative to the oxidation state of the rare earth metal, such that in principle any one or more rare earth oxides may be designated. Thus, by way of example, unless otherwise specified, the term “ceria” principally refers to the compounds CeO_{2,} Ce₂O₃, and any mixtures of the aforementioned compounds. According to a preferred meaning of the present invention, however, the term “ceria” designates the compound CeO₂. Same applies accordingly relative to the term “praseodymia” such that in general said term designates any one of the compounds Pr₂O₃, Pr₆O₁₁, PrO₂, and any mixtures of two or more thereof. According to a preferred meaning of the present invention, the term “praseodymia” designates the compound Pr₂O₃. Furthermore, it is noted that within the meaning of the present invention, the term “zirconia” designates zirconia, hafnia, and mixtures thereof.

As concerns the content of the one or more rare earth oxides other than ceria and praseodymia and/or of zirconia preferably further comprised in the composite oxide comprising ceria, praseodymia, and alumina, no particular restriction applies such that the content of the one or more rare earth oxides other than ceria and praseodymia and/or zirconia may be comprised in the range of anywhere from 0.2 to 40 mol-% calculated as the metal element of the respective rare earth oxide other than ceria and praseodymia, and based on 100 mol-% of the total moles of rare earth metals, aluminum, and optional zirconium in the composite oxide. According to the present invention it is however preferred that the content of the one or more rare earth oxides other than ceria and praseodymia and/or of zirconia preferably further comprised in the composite oxide ranges from 0.5 to 30 mol.-%, and more preferably from 1 to 20 mol.-%, more preferably from 1.5 to 15 mol.-%, more preferably from 2 to 12 mol.-%, more preferably from 2.5 to 10 mol.-%, more preferably from 3 to 8 mol.-%, more preferably from 3.5 to 7 mol.-%, and more preferably from 4 to 6 mol.-%. According to the present invention it is particularly preferred that the content of the one or more rare earth oxides other than ceria and praseodymia and/or of zirconia preferably further comprised in the composite oxide is comprised in the range of from 4.5 to 5.5 mol.-% calculated as the metal element of the respective rare earth oxide other than ceria and praseodymia, and based on 100 mol-% of the total moles of rare earth metals, aluminum, and optional zirconium in the composite oxide.

According to the present invention it is however particularly preferred that the composite oxide comprising ceria, praseodymia, and alumina contains 1 mol-% or less of zirconia calculated as the metal element and based on 100 mol-% of the total moles of rare earth metals, aluminum, and optional zirconium in the composite oxide, wherein more preferably the inventive composite oxide contains 0.5 mol-% or less of zirconia, more preferably 0.1 mol-%, more preferably 0.05 mol-% or less, more preferably 0.01 mol-% or less, more preferably 0.005 mol-% or less, more preferably 0.001 mol-% or less, more preferably 0.0005 mol-% or less, and more preferably 0.0001 mol-% or less of zirconia calculated as the metal element and based on 100 mol-% of the total moles of rare earth metals, aluminum, and optional zirconium in the composite oxide.

According to the present invention it is further preferred that the composite oxide comprising ceria, praseodymia, and alumina contains 1 wt.-% or less of alkaline earth metals calculated as the respective element and based on 100 wt.-% of the total amount of rare earth metal oxides, aluminum oxide, and optional zirconia contained in the composite oxide, wherein more preferably, the composite oxide contains 0.5 wt.-% or less of alkaline earth metals calculated as the element and more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt.-% or less, and more preferably 0.0001 wt.-% or less of alkaline earth metals calculated as the respective element and based on 100 wt.-% of the total amount of rare earth metal oxides, alumina, and optional zirconia contained in the composite oxide.

It is yet further preferred according to the present invention that the composite oxide comprising ceria, praseodymia, and alumina contains 1 mol-% or less of rare earth oxides other than ceria and praseodymia and/or of zirconia calculated as the metal element of the respective oxide and based on 100 mol-% of the total moles of rare earth metals, aluminum, and optional zirconium in the composite oxide, more preferably, 0.5 mol-% or less, more preferably 0.1 mol-% or less, more preferably 0.05 mol-% or less, more preferably 0.01 mol-% or less, more preferably 0.005 mol-% or less, more preferably 0.001 mol-% or less, more preferably 0.0005 mol-% or less, and more preferably 0.0001 mol-% or less of rare earth oxides other than ceria and praseodymia and/or of zirconia calculated as the metal element of the respective oxide and based on 100 mol-% of the total moles of rare earth metals, aluminum, and optional zirconium in the composite oxide.

As regards the composite oxide comprising ceria, praseodymia, and alumina according to the present invention, it is preferred that with respect to the solid solution of the composite oxide that alumina is dispersed in the solid solution of ceria and praseodymia. As regards the alumina particles dispersed in the solid solution of ceria and praseodymia, there is in principle no particular restriction as to the average particle size of the alumina particles provided that they are dispersed in the solid solution of ceria and praseodymia. Thus, by way of example, the ceria-praseodymia-alumina composite oxide may have a particle size of 200 nm or less, wherein it is preferred that the particle size of the ceria-praseodymia-alumina composite oxide is comprised in the range of from 0.1 to 150 nm, and more preferably of from 0.5 to 100 nm, more preferably of from 1 to 80 nm, more preferably of from 3 to 50 nm, more preferably of from 5 to 40 nm, more preferably of from 10 to 30 nm, and more preferably of from 15 to 25 nm. As regards the particle size of the ceria-praseodymia-alumina composite oxide, it is preferred that said average particle size is determined by transmission electron microscopy (TEM).

According to the present invention there is no particular restriction as to the method according to which the dispersion of alumina in the solid solution of ceria and praseodymia comprised in the composite oxide according to particular and preferred embodiments is obtained, provided that a dispersion of the alumina is achieved, and preferably of alumina according to any of the particular and preferred average particle sizes d50 previously defined. It is, however, preferred that the composite oxide containing alumina dispersed in the solid solution of ceria and praseodymia is obtained and/or obtainable by a co-precipitation method of ceria, praseodymia, and alumina employing one or more sources of ceria, praseodymia, and alumina, respectively, and/or is obtained and/or obtainable according to a flame spray pyrolysis method employing one or more sources of ceria, praseodymia, and alumina, respectively. As regards the one or more sources of alumina employed in the co-precipitation and/or flame spray pyrolysis methods according to which the composite oxide containing alumina dispersed in the solid solution of ceria and praseodymia is obtained and/or obtainable, no particular restriction applies, wherein preferably alumina particles such as contained in colloidal alumina solutions are employed in the method according to which the composite oxide is obtained and/or obtainable. As concerns the average particle size d50 of the alumina particles employed according to said preferred embodiments, no particular restriction applies provided that alumina may be dispersed in the solid solution of ceria and praseodymia, wherein preferably the average particle size d50 of alumina preferably employed in the method according to which the composite oxide is preferably obtained and/or obtainable is comprised in the range of from 1 to 800 nm, and more preferably of from 5 to 600 nm, more preferably of from 5 to 500 nm, more preferably of from 10 to 450 nm, more preferably of from 30 to 400 nm, more preferably of from 50 to 350 nm, more preferably of from 100 to 300 nm, and more preferably of from 150 to 250 nm. It is particularly preferred according to the present invention that the alumina particles preferably employed in the method according to which the composite oxide is preferably obtained and/or obtainable for providing alumina dispersed in the solid solution of ceria and praseodymia display an average particle size d50 which is comprised in the range of from 180 to 220 nm.

With respect to the alumina contained in the composite oxide of the present invention and which is preferably dispersed in the solid solution of ceria and praseodymia according to any of the aforementioned particular and preferred embodiments thereof, it is not excluded that alumina and in particular alumina dispersed in the solid solution of ceria and praseodymia contains one or more further metals. According to the present invention it is however preferred that the alumina contained in the composite oxide and in particular dispersed in the solid solution of ceria and praseodymia contains 1 mol-% or less of a further metal other than cerium, praseodymium, optional zirconium, and rare earth metals other than cerium and praseodymium as defined for particular and preferred embodiments of the present invention in the present application based on 100 mol-% of aluminum in the alumina and in particular of aluminum in the alumina dispersed in the solid solution of ceria and praseodymia, and more preferably 0.5 mol-% or less, more preferably 0.1mol-% or less, more preferably 0.05 mol-% or less, more preferably 0.01 mol-% or less, more preferably 0.005 mol-% or less, more preferably 0.001 mol-% or less, more preferably 0.0005 mol-% or less, and more preferably 0.0001 mol-% or less of a further metal other than cerium, praseodymium, optional zirconium, and rare earth metals other than cerium and praseodymium as defined for particular and preferred embodiments of the present invention in the present application.

As regards the physical and/or chemical properties of the composite oxide according to the present invention, no particular restrictions apply such that these may display any conceivable physical and/or chemical characteristics. Thus, by way of example, the composite oxide of the present invention may display any conceivable BET surface area. As described in the experimental section, however, it has quite unexpectedly been found that the BET surface of the inventive composite oxide is particularly stable such that it displays comparatively large BET surface areas even after having been exposed to aging conditions. Thus, by way of example, the inventive composite oxide may display a BET surface area in the range of anywhere from 15 to 300 m²/g after aging at 950° C. for 12 h in air containing 10 vol.-% of steam, wherein preferably the inventive composite oxide displays a BET surface area after aging under the aforementioned conditions comprised in the range of from 20 to 200 m²/g, and more preferably of from 25 to 150 m²/g, more preferably of from 30 to 100 m²/g, more preferably of from 35 to 80 m²/g, and more preferably of from 45 to 65 m²/g. According to the present invention it is particularly preferred that the composite oxide displays a BET surface area in the range of from 50 to 60 m²/g after aging at 950° C. for 12 hours in air containing 10 vol.-% of steam. As regards the BET surface area as defined in the present invention, it is noted that this refers in particular to a BET surface area determined according to DIN-ISO 9277.

According to the present invention, the inventive composite oxide preferably comprises one or more catalytic metals in addition to ceria, praseodymia, and alumina, and optional one or more rare earth oxides other than ceria and praseodymia and/or optional zirconia contained therein. As regards the one or more catalytic metals preferably contained in the composite oxide, no particular restriction exists such that any conceivable one or more catalytic metals may be further comprised in the inventive composite oxide. Thus, by way of example, the one or more catalytic metals preferably further comprised in the inventive composite oxide may be selected from the group consisting of transition metals and combinations of two or more thereof, wherein preferably the one or more catalytic metals are selected from the group consisting of platinum, rhodium, palladium, iridium, silver, gold, and combinations of two or more thereof, and more preferably from the group consisting of platinum, rhodium, palladium, and combinations of two or more thereof. According to the present invention it is particularly preferred that the one or more catalytic metals preferably further comprised in the inventive composite oxide comprise palladium, wherein more preferably palladium is further comprised in the inventive composite oxide as the catalytic metal.

Concerning the amounts in which the one or more catalytic metals preferably comprised in the inventive composite oxide are contained therein, no particular restrictions apply such that, by way of example, the one or more catalytic metals according to any of the particular and preferred embodiments defined in the foregoing may be contained in the inventive composite oxide in the range of from 0.05 wt.-% to 10 wt.-% based on the total weight of ceria, praseodymia, and alumina in the composite oxide. It is however preferred according to the present invention that the one or more catalytic metals preferably comprised in the inventive composite oxide are contained therein in an amount ranging from 0.1 to 5 wt.-%, and more preferably from 0.2 to 2 wt.-%, more preferably from 0.3 to 1 wt.-%, and more preferably from 0.4 to 0.6 wt.-% based on the total weight of ceria, praseodymia, and alumina in the composite oxide.

As regards the application in which the inventive composite oxide may be employed and in particular the compositions and/or apparatus in which the inventive composite oxide may be contained, no particular restriction applies. Thus, by way of example, the inventive composite oxide may be contained in a catalyst, catalyst support and/or catalyst component and in particular in a catalyst, catalyst support and/or catalyst component used in a catalyst for the oxidation of hydrocarbons and/or carbon monoxide and/or in a catalyst for the conversion of NOR. According to the present invention it is particularly preferred that the inventive composite oxide is comprised in a catalyst system for exhaust gas treatment, and preferably in a three-way catalytic convertor (TWC) or in a diesel oxidation catalyst (DOC).

According to the present invention, there is no particular restriction whatsoever as to the method according to which the inventive composite oxide may be obtained and/or is obtainable. It is, however, preferred according to the present invention that the inventive composite oxide is obtained and/or obtainable according to a co-precipitation method.

Therefore, the present invention also relates to a method of preparing a composite oxide comprising ceria, praseodymia, and alumina, preferably of a composite oxide according to any of the particular and preferred embodiments as defined in the present application, comprising:
(a) mixing one or more precursor compounds of ceria, one or more precursor compounds of praseodymia, optionally one or more precursor compounds of zirconia and/or optionally one or more precursor compounds of one or more rare earth oxides other than ceria and praseodymia, one or more precursor compounds of alumina, and one or more basic compounds in a solvent system for obtaining a suspension;
(b) optionally heating the suspension obtained in step (a);
(c) optionally adding one or more surfactant compounds to the suspension obtained in step (a) or (b);
(d) separating the solids from the suspension obtained in step (b) or (c);
(e) optionally washing the solids obtained in step (d);
(f) optionally drying the solids obtained in step (d) or (e);
(g) optionally calcining the solids obtained in step (d), (e), or (f);

wherein the cerium:praseodymium molar ratio of the suspension obtained in step (a) is 84:16 or less.

According to the present invention relating to the inventive method for preparing a composite oxide comprising ceria, praseodymia, and alumina, unless stated otherwise, the terms “cerium”, “praseodymium”, and “aluminum” refer to cerium, parseodymium, and aluminum contained in the one or more precursor compounds of ceria, praseodymia, and alumina, respectively, which are contained in the suspension obtained in step (a).

Furthermore, As regards the one or more precursor compounds of zirconia optionally added in step (a) it is noted that within the meaning of the present invention, the term “zirconia” designates zirconia, hafnia, and mixtures thereof.

According to the present invention, no particular restriction applies relative to the cerium:praseodymium molar ratio of the suspension obtained in step (a), provided that it is 84:16 or less. Thus, by way of examples, the cerium:praseodymium molar ratio of the suspension obtained in step (a) of the inventive method may be comprised in the range of anywhere from 15:85 to 80:20, wherein preferably the molar ratio is comprised in the range of from 25:75 to 75:25, more preferably from 35:65 to 70:30, more preferably from 40:60 to 65:35, more preferably from 42.5:57.5 to 62.5:37.5, more preferably from 45:55 to 60:40, and more preferably of from 47.5:52.5 to 57.5:42.5. According to the present invention it is particularly preferred that the cerium:praseodymium molar ratio of the suspension obtained in step (a) of the inventive method is in the range of from 50:50 to 55:45.

As regards the mixing of the one or more precursor compounds of ceria, praseodymia, alumina, optional zirconia and/or optional rare earth oxides other than ceria and praseodymia, and the one or more basic compounds in a solvent system for obtaining a suspension in step (a) of the inventive method, no particular restriction applies provided that the mixture of the components is homogenized such as e.g. by stirring, swaying, shaking, and/or sonification of the mixture after one or more of the aforementioned components have been added to the solvent system as well as in-between and/or during and preferably both in-between and during steps of the addition of one or more of said compounds. According to the inventive method it is preferred that the mixing in step (a) involves the stirring of the solvent system during and/or after addition of one or more of the compounds defined in step (a) of the inventive method, and preferably during and after addition thereof, respectively.

As regards the content of cerium in the suspension obtained in step (a) of the inventive method, no particular restriction applies such that in principle any conceivable amount of cerium may be contained therein provided that the cerium:praseodymium molar ratio of the suspension obtained in step (a) is 84:16 or less. Thus, by way of example, the content of cerium in the suspension obtained in step (a) of the inventive method may range anywhere from 15 to 80 mol.-% based on 100 mol.-% of the total moles of cerium, praseodymium, and aluminum in suspension obtained in step (a), wherein preferably the content of cerium is comprised in the range of from 20 to 75 mol.-%, and more preferably of from 25 to 70 mol.-%, more preferably from 30 to 65 mol.-%, more preferably from 35 to 60 mol.-%, more preferably from 40 to 55 mol.-%, and more preferably of from 42.5 to 52.5 mol.-%. According to the present invention it is particularly preferred that the content of cerium in the suspension obtained in step (a) is in the range of from 45 to 50 mol.-% based on 100 mol.-% of the total moles of cerium, praseodymium, and aluminum in the suspension obtained in step (a).

Furthermore, as regards the content of praseodymium in the suspension obtained in step (a) of the inventive method, no particular restriction applies such that in principle any conceivable amount of praseodymium may be contained therein provided that the cerium:praseodymium molar ratio of the composite oxide is 84:16 or less. Thus, by way of example, the content of praseodymium in the suspension obtained in step (a) of the inventive method may range anywhere from 15 to 80 mol.-% based on 100 mol.-% of the total moles of cerium, praseodymium, and aluminum in the suspension obtained in step (a), wherein preferably the content of praseodymium is comprised in the range of from 20 to 75 mol.-%, and more preferably of from 25 to 70 mol.-%, more preferably from 30 to 60 mol.-%, more preferably from 32.5 to 55 mol.-%, more preferably from 35 to 50 mol.-%, and more preferably of from 37.5 to 47.5 mol.-%. According to the present invention it is particularly preferred that the content of praseodymium in the suspension obtained in step (a) of the inventive method is in the range of from 40 to 45 mol.-% based on 100 mol.-% of the total moles of cerium, praseodymium, and aluminum in the suspension obtained in step (a).

Concerning the content of aluminum in the suspension obtained in step (a) of the inventive method, no particular restriction applies such that in principle any conceivable amount of aluminum may be contained therein. Thus, by way of example, the content of aluminum in the suspension obtained in step (a) of the inventive method may range anywhere from 0.2 to 70 mol.-% based on 100 mol.-% of the total moles of cerium, praseodymium, and aluminum in the suspension obtained in step (a), wherein preferably the content of aluminum is comprised in the range of from 0.5 to 55 mol.-%, and more preferably of from 1.0 to 45 mol.-%, more preferably from 1.5 to 35 mol.-%, more preferably from 2 to 30 mol.-%, more preferably from 2.5 to 25 mol.-%, more preferably from 3 to 20 mol.-%, more preferably from 3.5 to 15 mol.-%, more preferably from 4 to 12 mol.-%, and more preferably from 4.5 to 11 mol.-%. According to the present invention it is particularly preferred that the content of aluminum in the suspension obtained in step (a) of the inventive method is in the range of from 5 to 10 mol.-% based on 100 mol.-% of the total moles of cerium, praseodymium, and aluminum in the suspension obtained in step (a).

According to the inventive method, one or more precursor compounds of zirconia and/or one or more precursor compounds of one or more rare earth oxides other than ceria and praseodymia may be optionally added in step (a). As regards the one or more precursor compounds of one or more rare earth oxides other than ceria and praseodymia which is optionally added in step (a), no particular restriction applies such that any one or more precursor compounds of one or more rare earth oxides other than ceria and praseodymia may be added, wherein preferably the one or more precursor compounds of the one or more rare earth oxides other than ceria and praseodymia are selected from the group consisting of lanthana, neodymia, samaria, gadolinia, terbia, yttria, and combinations of two or more thereof, and more preferably from the group consisting of lanthana, neodymia, yttria, and combinations of two or more thereof. According to the present invention it is particularly preferred that the one or more precursor compounds of one or more rare earth oxides other than ceria and praseodymia optinally added in step (a) of the inventive method comprises one or more precursor compounds of yttria and/or neodymia, and more preferably comprises one or more precursor compounds of yttria. It is, however, yet further preferred according to the inventive method that the optional one or more precursor compounds of one or more rare earth oxides other than ceria and praseodymia added in step (a) is yttria and/or neodymia, preferably yttria.

As concerns the content of the one or more precursor compounds of one or more rare earth oxides other than ceria and praseodymia and/or of zirconia optionally added in step (a), no particular restriction applies such that the content of the one or more precursor compounds of the one or more rare earth oxides other than ceria and praseodymia and/or of zirconia may be comprised in the range of anywhere from 0.2 to 40 mol-% calculated as the metal element of the respective oxide, and based on 100 mol-% of the total moles of rare earth metals, aluminum, and optional zirconium in the suspension obtained in step (a). According to the present invention it is however preferred that the content of the one or more precursor compounds of the one or more rare earth oxides other than ceria and praseodymia and/or of zirconia optionally added in step (a) ranges from 0.5 to 30 mol.-%, and more preferably from 1 to 20 mol.-%, more preferably from 1.5 to 15 mol.-%, more preferably from 2 to 12 mol.-%, more preferably from 2.5 to 10 mol.-%, more preferably from 3 to 8 mol.-%, more preferably from 3.5 to 7 mol.-%, and more preferably from 4 to 6 mol.-%. According to the present invention it is particularly preferred that the content of the one or more precursor compounds of the one or more rare earth oxides other than ceria and praseodymia and/or of zirconia optionally added in step (a) is comprised in the range of from 4.5 to 5.5 mol.-% calculated as the metal element of the respective oxide, and based on 100 mol-% of the total moles of rare earth metals, aluminum, and optional zirconium in the suspension obtained in step (a).

According to the present invention it is however particularly preferred that the suspension obtained in step (a) contains 1 mol-% or less of zirconia calculated as the metal element and based on 100 mol-% of the total moles of rare earth metals, aluminum, and optional zirconium in the suspension obtained in step (a), wherein more preferably the suspension obtained in step (a) of the inventive method contains 0.5 mol-% or less of zirconia, more preferably 0.1 mol-%, more preferably 0.05 mol-% or less, more preferably 0.01 mol-% or less, more preferably 0.005 mol-% or less, more preferably 0.001 mol-% or less, more preferably 0.0005 mol-% or less, and more preferably 0.0001 mol-% or less of zirconia calculated as the metal element and based on 100 mol-% of the total moles of rare earth metals, aluminum, and optional zirconium in the suspension obtained in step (a).

According to the present invention it is further preferred that the suspension obtained in step (a) of the inventive method contains 1 wt.-% or less of alkaline earth metals calculated as the respective element and based on 100 wt.-% of the total amount of rare earth metal oxides, aluminum oxide, and optional zirconia contained in the suspension obtained in step (a), wherein more preferably, the suspension obtained in step (a) contains 0.5 wt.-% or less of alkaline earth metals calculated as the element and more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt.-% or less, and more preferably 0.0001 wt.-% or less of alkaline earth metals calculated as the respective element and based on 100 wt.-% of the total amount of rare earth metal oxides, alumina, and optional zirconia contained in the suspension obtained in step (a).

It is yet further preferred according to the present invention that the suspension obtained in step (a) of the inventive method contains 1 mol-% or less of rare earth oxides other than ceria and praseodymia and/or of zirconia calculated as the metal element of the respective oxide and based on 100 mol-% of the total moles of rare earth metals, aluminum, and optional zirconium contained in the suspension obtained in step (a), more preferably, 0.5 mol-% or less, more preferably 0.1 mol-% or less, more preferably 0.05 mol-% or less, more preferably 0.01 mol-% or less, more preferably 0.005 mol-% or less, more preferably 0.001 mol-% or less, more preferably 0.0005 mol-% or less, and more preferably 0.0001 mol-% or less of rare earth oxides other than ceria and praseodymia and/or of zirconia calculated as the metal element of the respective oxide and based on 100 mol-% of the total moles of rare earth metals, aluminum, and optional zirconium contained in the suspension obtained in step (a).

As regards the one or more precursor compounds of ceria and/or the one or more precursor compounds of praseodymia added in step (a), no particular restrictions apply relative to the type of the one or more precursor compounds provided that they may be mixed with the one or more precursor compounds of alumina and the one or more basic compounds in a solvent system for obtaining a suspension. According to the present invention it is however preferred that, independently form one another, the one or more precursor compounds of ceria and/or the one or more precursor compounds of praseodymia are provided as salts in step (a), wherein more preferably both the one or more precursor compounds of ceria and/or the one or more precursor compounds of praseodymia are provided as salts. Regarding the specific types of salts which may be employed according to said preferred embodiments of the present invention, no particular restrictions apply such that any suitable type of salts may be employed, salts which may be entirely solvated by the solvent of the system added in step (a) being preferred. Thus, by way of example, the salts which independently from one another may serve as the one or more precursor compounds of ceria and/or the one or more precursor compounds of praseodymia may be selected from the group consisting of sulfates, nitrates, phosphates, chlorides, bromides, acetates, and combinations of two or more thereof, wherein preferably the salts are, independently form one another, selected from the group consisting of nitrates, chlorides, acetates, and combinations of two or more thereof. According to the inventive method it is particularly preferred that, independently form one another, the one or more precursor compounds of ceria and/or the one or more precursor compounds of praseodymia are nitrates.

Concerning the one or more precursor compounds of alumina added in step (a) of the inventive method, again no particular restrictions apply provided that these may be admixed with the one or more precursor compounds of ceria and praseodymia and with the one or more basic compounds in a solvent system for obtaining a suspension. Thus, by way of example, the one or more precursor compounds of alumina may be selected from the group consisting of aluminum salts, aluminum oxide hydroxides, aluminum hydroxides, alumina, and combinations of two or more thereof, wherein preferably the one or more precursor compounds of alumina employed in step (a) are selected from the group consisting of aluminum sulfates, aluminum nitrates, aluminum phosphates, aluminum chlorides, aluminum bromides, aluminum acetates, diaspore, boehmite, akdalaite, gibbsite, bayerite, doyleite, nordstrandite, and combinations of two or more thereof, wherein more preferably the one or more precursor compounds of alumina are selected from the group consisting of aluminum sulfate, aluminum nitrate, aluminum chloride, diaspore, boehmite, akdalaite, and combinations of two or more thereof. According to the inventive method for preparing a composite oxide, it is particularly preferred that the one or more precursor compounds of alumina added in step (a) comprise aluminum nitrate and/or boehmite, and preferably comprise aluminum nitrate. According to the present invention it is further preferred that the one or more precursor compounds of alumina added in step (a) of the inventive method are aluminum nitrate and/or boehmite, wherein more preferably the one or more precursor compounds of alumina is aluminum nitrate.

According to the inventive method for the preparation of a composite oxide it is alternatively preferred that the one or more precursor compounds of alumina added in step (a) are selected from the group consisting of colloidal alumina, colloidal aluminum oxide hydroxides, colloidal aluminum hydroxides, and combinations of two or more thereof. Thus, by way of example, it is alternatively preferred according to the present invention that the one or more precursor compounds of alumina added in step (a) of the inventive method are selected from the group consisting of colloidal diaspore, colloidal boehmite, colloidal akdalaite, colloidal gibbsite, colloidal bayerite, colloidal doyleite, colloidal nordstrandite, and combinations of two or more thereof, wherein preferably the one or more precursor compounds of alumina are selected from the group consisting of colloidal diaspore, colloidal boehmite, colloidal akdalaite, colloidal gibbsite, colloidal bayerite, colloidal doyleite, colloidal nordstrandite, and combinations of two or more thereof. According to the present invention it is however particularly preferred that the one or more precursor compounds of alumina added in step (a) comprise colloidal boehmite, wherein even more preferably the one or more precursor compounds of alumina added in step (a) of the inventive method is colloidal boehmite.

As regards the term “colloid” as employed in the present application, unless specified otherwise, said term preferably designates a colloid having an average particle size d50 of 1 pm or less, and more preferably having an average particle size d50 comprised in the range of from 1 to 800 nm, more preferably of from 5 to 600 nm, more preferably of from 5 to 500 nm, more preferably of from 10 to 450 nm, more preferably of from 30 to 400 nm, more preferably of from 50 to 350 nm, more preferably of from 100 to 300 nm, and more preferably of from 150 to 250 nm. According to the present invention it is particularly preferred that, unless specified otherwise, the term “colloid” as employed in the present application designates a colloid having an average particle size d50 comprised in the range of from 180 to 220 nm According to the present invention, the d50 values as indicated in the present application are preferably obtained according to ISO 22412:2008-05.

In step (a) of the inventive method, one or more basic compounds in a solvent system is provided for admixture with the one or more precursor compounds of ceria, praseodymia, and alumina for obtaining a suspension by admixture of the components. As concerns the one or more basic compounds which may be provided in the solvent system, no particular restriction applies such that any suitable basic compound may be employed. Thus, in principle, any one or more basic compounds selected among the group consisting of Bronstedt bases and Lewis bases including combinations of two or more thereof may be employed. According to the inventive method for the preparation of a composite oxide, it is however preferred that the one or more basic compounds added in step (a) in the solvent system are selected from the group consisting of alkali metal hydroxides, alkaline earth metal hydroxides, ammonia, alkylammonium hydroxides, and combinations of two or more thereof, and more preferably from the group consisting of sodium hydroxide, potassium hydroxide, barium hydroxide, ammonia, (C₁-C₆)tetraalkylammonium hydroxides, and combinations of two or more thereof, and more preferably from the group consisting of barium hydroxide, ammonia, tetramethylammonium hydroxide, tetraethylammonium hydroxide, tetrapropylammonium hydroxide, tetrabutylammonium hydroxide, and combinations of two or more thereof. According to the present invention it is particularly preferred that the one or more basic compounds employed in step (a) of the inventive method comprise ammonia, wherein more preferably ammonia is used as the basic compound in step (a).

As regards the order in which the one or more precursor compounds of ceria, praseodymia, and alumina, and the one or more basic compounds in a solvent system are admixed in step (a) of the inventive method, no particular restrictions apply provided that a suspension may be obtained. According to the present invention it is however preferred that in step (a), the one or more precursor compounds of ceria, the one or more precursor compounds of praseodymia, the optional one or more precursor compounds of zirconia, the optional one or more precursor compounds of the one or more rare earth oxides other than ceria and praseodymia, and the one or more precursor compounds of alumina are respectively added to the solvent system containing the one or more basic compounds. According to said preferred embodiment, there is no particular preference as to the exact order in which the one or more precursor compounds of ceria, praseodymia, alumina, optional zirconia, and optional one or more precursor compounds of one or more rare earth oxides other than ceria and praseodymia are added to the solvent system containing the one or more basic compounds, such that any suitable sequence may be employed including the consecutive addition of the aforementioned one or more precursor compounds and/or the simultaneous addition of two or more of the aforementioned precursor compounds, including any suitable combination of consecutive and simultaneous addition of two or more of the aforementioned precursor compounds. It is however preferred according to the present invention that the one or more precursor compounds of praseodymia, the optional one or more precursor compounds of zirconia, the optional one or more precursor compounds of one or more rare earth oxides other than ceria and praseodymia, and the one or more precursor compounds of alumina are dissolved and/or dispersed in a single solution, wherein preferably said single solution containing the one or more precursor compounds of praseodymia, the optional one or more precursor compounds of zirconia, the optional one or more precursor compounds of one or more rare earth oxides other than ceria and praseodymia, and the one or more precursor compounds of alumina, and a separate solution containing the one or more precursor compounds of ceria are added simultaneously or consecutively, preferably consecutively, into the solvent system containing the one or more basic compounds, wherein more preferably the solution containing the one or more precursor compounds of ceria is added to the solvent system containing the one or more basic compounds prior to the addition of the separate solution containing the one or more precursor compounds of praseodymia, the optional one or more precursor compounds of zirconia, the optional one or more precursor compounds of one or more rare earth oxides other than ceria and praseodymia, and the one or more precursor compounds of alumina to the resulting mixture.

According to the present invention it is alternatively particularly preferred that the one or more precursor compounds of praseodymia, the optional one or more precursor compounds of zirconia, and the optional one or more precursor compounds of one or more rare earth oxides other than ceria and praseodymia are dissolved and/or dispersed in a single solution, and the one or more precursor compounds of alumina are dissolved and/or dispersed in a separate solution, wherein the solution containing the one or more precursor compounds of alumina is added to the solvent system containing the one or more basic compounds prior to the addition of the solution containing the one or more precursor compounds of praseodymia, the optional one or more precursor compounds of zirconia, and the optional one or more precursor compounds of one or more rare earth oxides other than ceria and praseodymia and of a separate solution containing the one or more precursor compounds of ceria, wherein the solution containing the one or more precursor compounds of praseodymia, the optional one or more precursor compounds of zirconia, and the optional one or more precursor compounds of one or more rare earth oxides other than ceria and praseodymia and the separate solution containing the one or more precursor compounds of ceria are added simultaneously or consecutively, preferably consecutively, into the mixture of the one or more precursor compounds of alumina and the one or more basic compounds in the solvent system, wherein more preferably the solution containing the one or more precursor compounds of ceria is added prior to the solution containing the one or more precursor compounds of praseodymia, the optional one or more precursor compounds of zirconia, and the optional one or more precursor compounds of one or more rare earth oxides other than ceria and praseodymia to the resulting mixture of the one or more precursor compounds of ceria, the one or more precursor compounds of alumina, and the one or more basic compounds in the solvent system.

As regards the solvent system employed in step (a) of the inventive method for preparing a composite oxide in which the one or more basic compounds according to any one of the particular and preferred embodiments of the present invention are contained, no particular restrictions apply with respect to the one or more solvents which may be contained therein, neither with respect to their type, nor with respect to their number and/or respective amounts. Thus, by way of example, any suitable solvent or mixture of solvents may be employed in the solvent system, wherein said solvents may be principally selected from the group consisting of non-polar solvents, polar aprotic solvents, and polar protic solvents, wherein in the event that two or more solvents are contained in the solvent system, it is preferred that said two or more solvents are at least partly miscible, wherein more preferably the two or more solvents are chosen with respect to their type and to their amount such that the solvent system consists of a single phase. According to the present invention it is further preferred that the one or more solvents contained in the solvent system added in step (a) of the inventive method comprise one or more polar protic solvents, wherein the one or more solvents are preferably selected from the group consisting of alcohols, water, and mixtures of two or more thereof, more preferably from the group consisting of (C₁-C₅)alcohols, water, and mixtures of two or more thereof, and more preferably from the group consisting of (C₁-C₅)alcohols, water, and mixtures of two or more thereof, more preferably from the group consisting of methanol, ethanol, propanol, water, and mixtures of two or more thereof, wherein more preferably the solvent system comprises water, wherein even more preferably water is the solvent used for the solvent system in step (a).

As regards the solution or solutions in which the one or more precursor compounds of ceria, praseodymia, alumina, optional zirconia, and optional one or more precursor compounds of one or more rare earth oxides other than ceria and praseodymia are dissolved prior to being added to the solvent system containing the one or more basic compounds in step (a) according to particular embodiments of the inventive method, again, no particular restrictions apply neither with respect to the type nor with respect to the number of solvents which may be employed for preparing the respective solution or solutions, provided that independently from one another, at least a portion and preferably all of the one or more precursor compounds of ceria, praseodymia, alumina, optional zirconia, and optional one or more precursor compounds of one or more rare earth oxides other than ceria and praseodymia may be respectively dissolved therein. According to the present invention it is however particularly preferred that the one or more solvents employed for preparing the aforementioned solution or solutions in which the one or more precursor compounds of ceria, praseodymia, alumina, optional zirconia, and optional one or more precursor compounds of one or more rare earth oxides other than ceria and praseodymia are preferably dissolved and/or dispersed are chosen such that they are at least in part miscible with the solvent system containing the one or more basic compounds, wherein even more preferably the solution or solutions are chosen such that the one or more solvents contained therein are completely miscible with the solvent system containing the one or more basic compounds such that the suspension resulting in step (a) after admixture of the individual components contains a single phase of a solvent system in which the dispersed particles are contained.

Therefore, it is preferred according to the inventive method that independently from one another the solvent system in step (a) and the solution or solutions in which the one or more precursor compounds of ceria, the one or more precursor compounds of praseodymia, the optional one or more precursor compounds of zirconia, the optional one or more precursor compounds of one or more rare earth oxides other than ceria and praseodymia, and/or the one or more precursor compounds of alumina are preferably dissolved and/or dispersed comprise one or more solvents selected from the group consisting of alcohols, water, and mixtures of two or more thereof, preferably from the group consisting of (C₁-C₅)alcohols, water, and mixtures of two or more thereof, more preferably from the group consisting of (C₁-C₅)alcohols, water, and mixtures of two or more thereof, more preferably from the group consisting of methanol, ethanol, propanol, water, and mixtures of two or more thereof, wherein more preferably the solvent system and/or said solutions comprise water, wherein more preferably water is the solvent used for the solvent system in steps (a) and or for the solution or solutions in which the one or more precursor compounds of ceria, the one or more precursor compounds of praseodymia, the optional one or more precursor compounds of zirconia, the optional one or more precursor compounds of one or more rare earth oxides other than ceria and praseodymia, and/or the one or more precursor compounds of alumina are preferably dissolved and/or dispersed.

Concerning the solvent system containing the one or more basic compounds added in step (a), there is no particular restriction as to the pH value which said solvent system may have, provided that it is basic, i.e. that the pH value is greater than 7 prior to the addition of any of the one or more precursor compounds of ceria, praseodymia, alumina, optional zirconia, and optional one or more precursor compounds of one or more rare earth oxides other than ceria and praseodymia. Thus, by way of example, the solvent system, prior to the addition of any of the aforementioned precursor compounds may display a pH comprised anywhere in the range from 10 to 14, wherein preferably the pH is comprised in the range of from 11 to 13, and more preferably in the range of from 11.5 to 12.5.

According to the present invention, the pH values as defined in the present application preferably refer to the values obtained using a glass electrode, more preferably using a glass pH electrode, and more preferably using a glass pH electrode referenced against a silver chloride electrode.

As regards the pH of the solvent system containing the one or more basic compounds during the addition of the one or more precursor compounds of ceria, praseodymia, alumina, optional zirconia, and optional one or more precursor compounds of one or more rare earth oxides other than ceria and praseodymia, there is no particular restriction as to the pH of the resulting mixture provided that a suspension may be obtained in step (a). It is, however, preferred according to the inventive method that the pH of the solvent system containing one or more basic compounds is adjusted during the addition of the aforementioned one or more precursor compounds, preferably such that a pH of at least 7 during the entire addition method and preferably of greater than 7 is maintained. Therefore, it is preferred according to the present invention that in step (a) during the addition of the one or more precursor compounds of ceria, the one or more precursor compounds of praseodymia, the optional one or more precursor compounds of zirconia, the optional one or more precursor compounds of one or more rare earth oxides other than ceria and praseodymia to the solvent system containing the one or more basic compounds, the pH of the resulting solution is maintained in the range of from 7 to 14 during the addition of the further precursor compounds, and preferably in the range from 7.5 to 13.5, more preferably from 8 to 13, more preferably from 8.5 to 12.5, and more preferably from 9 to 12.

According to optional step (b) of the inventive method for the preparation of a composite oxide, the suspension obtained instep (a) may be heated. As regards the temperature to which the suspension obtained in step (a) is optionally heated, no restriction applies such that any conceivable temperature for said optional heating step may be chosen, provided that a composite oxide comprising ceria, praseodymia, and alumina, and preferably a composite oxide according to any of the particular and preferred embodiments of the present invention as described in the present application may be obtained. Thus, by way of example, the optional heating in step (b) may be carried out at a temperature anywhere in the range of from 80 to 250° C., wherein preferably the temperature is comprised in the range of from 100 to 200° C., more preferably from 125 to 175° C., and more preferably of from 140 to 160° C.

Concerning the further conditions under which heating in step (b) of the inventive method for preparing a composite oxide may be preformed, again no particular restrictions apply, such that optional heating in step (b) may be carried out under any suitable pressure and for any suitable duration, provided that a composite oxide comprising ceria, praseodymia, and alumina and preferably a composite oxide according to any of the particular and preferred embodiments of the inventive composite oxide as defined in the present application may be obtained. According to the present invention it is however preferred that heating in step (b) is carried out at an elevated pressure relative to normal pressure, wherein in particular it is preferred that heating in step (b) is carried out under autogenous pressure, and preferably under solvothermal conditions, wherein depending on the one or more solvents contained in the solvent system of the suspension resulting from mixing in step (a) the optional heating in step (b) is preferably performed under hydrothermal conditions. As concerns the duration of the optional heating in step (b) on the other hand, no particular restrictions apply such that said optional heating in step (b) may be performed for a duration ranging anywhere from 0.1 to 24 h, wherein preferably the duration of the optional heating is comprised in the range of from 0.2 to 12 hours, and more preferably of from 0.5 to 6 hours, more preferably of from 1 to 4 hours, and more preferably of from 1.5 to 3 hours.

As regards the optional step (c) of adding one or more surfactant compounds to the suspension obtained in step (a) or in (b), again, no particular restriction applies neither with respect to the number nor with respect to the type and/or to the amount of the one or more surfactant compounds which may optionally be added in step (c) of the inventive method, provided that a composite oxide comprising ceria, praseodymia, and alumina and preferably a composite oxide according to any of the particular and preferred embodiments of the inventive composite as described in the present application may be obtained. Thus, by way of example, the one or more surfactant compounds optionally added in step (c) of the inventive method may be selected among organic surfactant compounds, and more preferably among ionic and non-ionic organic surfactants and combinations thereof. According to the present invention it is however preferred that the one or more surfactant compounds are selected from the group consisting of anionic organic surfactants, non-ionic organic surfactants, and combinations of two or more thereof, more preferably from the group consisting of polyalkylene glycols, carboxylic acids, carboxylic salts, carboxymethylated fatty alcohol ethoxylates, and combinations of two or more thereof, more preferably from the group consisting of polyethylene glycols, carboxylic acids, carboxylic salts, and combinations of two or more thereof, more preferably from the group consisting of carboxylic acids, carboxylic salts, and combinations of two or more thereof, more preferably from the group consisting of carboxylic acids, and combinations of two or more thereof, more preferably from the group consisting of (C₆-C₁₈)carboxylic acids, and combinations of two or more thereof, more preferably from the group consisting of (C₈-C₁₆)carboxylic acids, and combinations of two or more thereof, more preferably from the group consisting of (C₁₀-C₁₄)carboxylic acids, and combinations of two or more thereof, wherein more preferably said one or more surfactant compounds comprise lauric acid, wherein more preferably lauric acid is used as the surfactant compound in step (c).

In optional step (e) of the inventive method for preparing a composite oxide, the solids obtained in step (d) after separation of the solids from the suspension obtained in step (b) or in (d) are optionally washed. Concerning the solvent system or solution with which the solids may be washed in step (e), no particular restriction applies such that any suitable solvent system or solution may be employed to this effect, wherein preferably the one or more solvents employed in the solvent system or the solution correspond to the one or more solvents employed in the solvent system added in step (a) or for the preparation of the solution or solutions preferably employed for dissolving and/or dispersing the one or more precursor compounds of ceria, praseodymia, alumina, optional zirconia, and/or optional one or more precursor compounds of one or more rare earth oxides other than ceria and praseodymia. According to the present invention it is particularly preferred that the one or more solvents contained in the solvent system or solution employed for the washing of the solids in optional step (e) corresponds to the one or more solvents contained in the solvent system containing the one or more basic compounds in step (a) according to any of the particular and preferred embodiments of the inventive method as defined in the present application. According to the present invention it is particularly preferred that in optional step (e) the solids are washed with an aqueous solution, and more preferably with an aqueous base. Concerning the base which may be employed in the preferred aqueous solution used in step (e), no particular restrictions apply, such that any suitable base or mixture of bases may be employed therein provided that these may be dissolved in water. According to the present invention it is however particularly preferred that the base preferably employed in step (e) corresponds to the one or more basic compounds contained in the solvent system added in step (a) according to any of the particular and preferred embodiments thereof as described in the present application. Thus, it is particularly preferred that in step (e) the solids are washed with aqueous ammonia, wherein more preferably the aqueous base and preferably the aqueous ammonia used in step (e) has a pH ranging from 10 to 14, more preferably from 11 to 13, and more preferably from 11.5 to 12.5.

In optional step (f) of the inventive method, the solids obtained in step (d) or in optional step (e) may be dried. In this respect, there is no particular restriction as to the temperature, nor with respect to the duration for the optional drying in step (f). Thus, by way of example, drying may be performed at a temperature comprised in the range of anywhere from 20 to 100° C., wherein preferably drying is preformed at a temperature comprised in the range of from 25 to 80° C., more preferably of from 30 to 60° C., more preferably of from 35 to 50° C., and more preferably of from 38 to 45° C. Furthermore, drying may be performed for a duration ranging anywhere from 0.5 hours to 2 days, wherein more preferably drying in optional step (f) is carried out for a duration comprised in the range of from 1 hour to 1.5 days, more preferably from 2 hours to 1 day, more preferably from 4 hours to 18 hours, more preferably from 6 hours to 14 hours, and more preferably from 8 hours to 12 hours.

Furthermore, according to optional step (g) of the inventive method for preparing a composite oxide, the solids obtained in step (d), (e) or (f) are calcined. As for the drying procedure in optional step (f), there is also no particular restriction whatsoever neither concerning the temperature of calcination, nor with respect to the duration thereof provided that a composite oxide comprising ceria, praseodymia, and alumina and preferably a composite oxide according to any of the particular and preferred embodiments of the inventive composite oxide as described in the present application may be obtained. Thus, by way of example, the solids may be calcined in optional step (g) at a temperature comprised in the range of anywhere from 200 to 1000° C., wherein preferably the temperature of calcination is comprised in the range of from 300 to 900° C., more preferably from 400 to 800° C., more preferably from 500 to 700° C., and more preferably from 550 to 650° C. Regarding the duration of the optional calcination of step (g), on the other hand, it may range of anywhere from 0.1 hours to 2 days, wherein preferably the duration of the calcination in optional step (g) is comprised in the range of from 0.2 hours to 1.5 days, more preferably from 0.5 hours to 1 day, more preferably from 1 hour to 12 hours, more preferably from 2 hours to 8 hours, and more preferably from 3 to 5 hours.

According to the present invention, the inventive method may further comprise any additional workup steps or subsequent steps for the further conversion of the solids obtained in any of steps (d), (e), (f), or (g). Thus, it is preferred according to the present invention that the inventive method further comprises a step of
(h) impregnating the solids obtained in step (d), (e), (f), or (g) with one or more catalytic metals, preferably by incipient wetness impregnation.

As regards the step of impregnating the solids in step (h), no particular restrictions apply relative to the method by which impregnation of the solids may be achieved such that any suitable impregnation method may be used to this effect. Accordingly, impregnation may be achieved by bringing the solids obtained in anyone of steps (d), (e), (f), and/or (g) into contact with a solution containing one or more catalytic metals. According to the present invention it is however preferred that impregnation in step (h) is achieved by incipient wetness.

Concerning the one or more catalytic metals which are preferably impregnated into the solids obtained in steps (d), (e), (f), and/or (g) according to step (h), no particular restriction applies such that any suitable one or more catalytic metals may be employed to this effect. According to the present invention it is however preferred that the one or more catalytic metals are selected from the group consisting of transition metals and combinations of two or more thereof, and more preferably from the group consisting of platinum, rhodium, palladium, iridium, silver, gold, and combinations of two or more thereof, more preferably from the group consisting of platinum, rhodium, palladium, and combinations of two or more thereof. According to the invention it is however particularly preferred that the one or more catalytic metals comprise palladium, wherein more preferably palladium is the catalytic metal impregnated in step (h).

In addition to step (h), it is further preferred according to the present invention that the inventive method further comprises a step of
(i) drying and/or calcining the solids obtained in step (h).

As for the optional drying and the optional calcining of the solids obtained in step (d) or (e) and (d), (e), or (f), respectively, in steps (f) and (g), there is also no particular restriction neither with respect to the temperature, nor with respect to the duration of the respective drying and calcining of the solids in step (i). Thus, as concerns the optional drying of the solids obtained in step (h) in step (i), said drying may be performed at a temperature comprised in the range of anywhere from 20 to 100° C., wherein drying in step (i) is preformed at a temperature comprised in the range of from 25 to 80° C., more preferably of from 30 to 60° C., more preferably from 35 to 50° C., and more preferably from 38 to 45° C. Furthermore, any suitable duration of drying may be chosen in step (i), such that the duration of drying may range anywhere from 0.5 hours to 2 days, wherein preferably the drying is performed for a duration comprised in the range of from 1 hour to 1.5 days, more preferably from 2 hours to 1 day, more preferably from 4 to 18 hours, more preferably from 6 to 14 hours, and more preferably from 8 to 12 hours.

Same applies accordingly relative to the calcination in step (i), such that it may for example be carried out at a temperature ranging anywhere from 200 to 900° C., wherein more preferably calcination in step (i) is preformed at a temperature comprised in the range of from 300 to 800° C., more preferably from 400 to 700° C., and more preferably from 500 to 600° C. Relative to the duration of calcination in step (i), said calcination may be performed for a duration ranging anywhere from 0.1 hours to 2 days, wherein preferably the calcination is performed for a duration comprised in the range of from 0.2 hours to 1.5 days, more preferably from 0.5 hours to 1 day, more preferably from 1 to 12 hours, more preferably from 2 to 8 hours, and more preferably from 3 to 5 hours.

Besides providing a composite oxide comprising ceria, praseodymia, and alumina according to any of the aforementioned particular and preferred embodiments described in the present application, the present invention further relates to a composite oxide obtained and/or obtainable by the inventive method according to any of the particular and preferred embodiments thereof as defined in the present application.

Furthermore, the present invention also relates to a process of treating an exhaust gas stream comprising
(1) providing an exhaust gas stream;
(2) contacting the exhaust gas stream of step (1) with a catalyst comprising a composite oxide comprising ceria, praseodymia, and alumina according to any of the particular and preferred embodiments described in the present application relative to the inventive composite oxide as such and as obtained and/or obtainable according to any of the particular and preferred embodiments of the inventive method as described in the present application.

As regards the exhaust gas stream provided in step (1) of the inventive process, no particular restriction applies provided that one or more components of the exhaust gas stream may be at least partly converted by the inventive composite oxide with which it is contacted in step (2). According to the present invention it is however preferred that the exhaust gas stream provided in step (1) contains at least one of a hydrocarbon, carbon monoxide, and NOₓ, wherein preferably the exhaust gas stream comprises at least carbon monoxide and NOₓ, wherein more preferably the exhaust gas stream comprises at least one hydrocarbon, carbon monoxide, and NOₓ. According to the present invention it is particularly preferred that the exhaust gas stream provided in step (1) of the inventive process is from a diesel or gasoline engine, and more preferably from a gasoline engine.

Finally, the present invention relates to the use of a composite oxide according to any of the particular and preferred embodiments of the present invention as described in the present application or of a composite oxide obtained and/or obtainable according to anyone of the particular and preferred embodiments of the inventive process as described in the present application. In principle, there is no restriction relative to the application in which the aforementioned composite oxide may be employed, wherein preferably the composite oxide is used as a catalyst, catalyst support, or catalyst component. According to the present invention it is further preferred that in the inventive use, the composite oxide according to any of the particular and preferred embodiments of the present invention as described in the present application is used as an oxygen storage component, and preferably as a catalyst for the oxidation of hydrocarbons and/or carbon monoxide and/or for the conversion of NO_{R}, preferably for the oxidation of hydrocarbons and carbon monoxide as well as for the conversion of NO_{R}, preferably in the treatment of exhaust gas, more preferably in the treatment of exhaust gas from a diesel or a gasoline engine, and more preferably in the treatment of exhaust gas from a gasoline engine.

The present invention is further characterized by the following preferred embodiments, including the combinations of embodiments indicated by the respective dependencies:
1. A composite oxide comprising ceria, praseodymia, and alumina, wherein the cerium:praseodymium molar ratio of the composite oxide is 84:16 or less, and is preferably comprised in the range of from 15:85 to 80:20, more preferably from 25:75 to 75:25, more preferably from 35:65 to 70:30, more preferably from 40:60 to 65:35, more preferably from 42.5:57.5 to 62.5:37.5, more preferably from 45:55 to 60:40, more preferably from 47.5:52.5 to 57.5:42.5, more preferably from 50:50 to 55:45.
2. The composite oxide according to embodiment 1, wherein the content of cerium is in the range of from 15 to 80 mol.-% based on 100 mol.-% of the total moles of cerium, praseodymium, and aluminum in the composite oxide, preferably from 20 to 75 mol.-%, more preferably from 25 to 70 mol.-%, more preferably from 30 to 65 mol.-%, more preferably from 35 to 60 mol.-%, more preferably from 40 to 55 mol.-%, more preferably from 42.5 to 52.5 mol.-%, more preferably from 45 to 50 mol.-%.
3. The composite oxide according to embodiment 1 or 2, wherein the content of praseodymium is in the range of from 15 to 80 mol.-% based on 100 mol.-% of the total moles of cerium, praseodymium and aluminum in the composite oxide, preferably from 20 to 75 mol.-%, preferably from 25 to 70 mol.-%, more preferably from 30 to 60 mol.-%, more preferably from 32.5 to 55 mol.-%, more preferably from 35 to 50 mol.-%, more preferably from 37.5 to 47.5 mol.-%, more preferably from 40 to 45 mol.-%.
4. The composite oxide according to any of embodiments 1 to 3, wherein the content of aluminum is in the range of from 0.2 to 70 mol.-% based on 100 mol.-% of the total moles of cerium, praseodymium and aluminum in the composite oxide, preferably from 0.5 to 55 mol.-%, more preferably from 1.0 to 45 mol.-%, more preferably from 1.5 to 35 mol.-%, more preferably from 2 to 30 mol.-%, more preferably from 2.5 to 25 mol.-%, more preferably from 3 to 20 mol.-%, more preferably from 3.5 to 15 mol.-%, more preferably from 4 to 12 mol.-%, more preferably from 4.5 to 11 mol.-%, more preferably from 5 to 10 mol.-%.
5. The composite oxide according to any of embodiments 1 to 4, which further comprises one or more rare earth oxides other than ceria and praseodymia and/or further comprises zirconia, said one or more rare earth oxides other than ceria and praseodymia being preferably selected from the group consisting of lanthana, neodymia, samaria, gadolinia, terbia, yttria, and combinations of two or more thereof, wherein more preferably the one or more rare earth oxides other than ceria and praseodymia is selected from the group consisting of lanthana, neodymia, yttria, and combinations of two or more thereof, and wherein more preferably the composite oxide further comprisesyttria and/or neodymia, preferably yttria.
6. The composite oxide according to embodiment 5, wherein the content of the one or more rare earth oxides other than ceria and praseodymia and/or of zirconia is in the range of from 0.2 to 40 mol.-% calculated as the metal element of the respective oxide and based on 100 mol.-% of the total moles of rare earth metals, aluminum, and optional zirconium in the composite oxide, preferably from 0.5 to 30 mol.-%, more preferably from 1 to 20 mol.-%, more preferably from 1.5 to 15 mol.-%, more preferably from 2 to 12 mol.-%, more preferably from 2.5 to 10 mol.-%, more preferably from 3 to 8 mol.-%, more preferably from 3.5 to 7 mol.-%, more preferably from 4 to 6 mol.-%, more preferably from 4.5 to 5.5 mol.-%.
7. The composite oxide according to any of embodiments 1 to 6, wherein the alumina is dispersed in the solid solution of ceria and praseodymia, wherein preferably the particle size of the resulting ceria-praseodymia-alumina composite oxide as determined by transmission electron microscopy (TEM) is 200 nm or less, and is preferably in the range of from 0.1 to 150 nm, more preferably of from 0.5 to 100 nm, more preferably of from 1 to 80 nm, more preferably of from 3 to 50 nm, more preferably of from 5 to 40 nm, more preferably of from 10 to 30 nm, and more preferably of from 15 to 25 nm.
8. The composite oxide according to any of embodiments 1 to 7, wherein the composite oxide displays a BET surface area determined according to DIN-ISO 9277 in the range of from 15 to 300 m²/g after aging at 950° C. for 12 h in air containing 10 vol.-% of steam, preferably in the range of from 20 to 200 m²/g, more preferably from 25 to 150 m²/g, more preferably from 30 to 100 m²/g, more preferably from 35 to 80 m²/g, more preferably from 45 to 65 m²/g, and more preferably from 50 to 60 m²/g.
9. The composite oxide according to any of embodiments 1 to 8, which further comprises one or more catalytic metals preferably selected from the group consisting of transition metals and combinations of two or more thereof, more preferably from the group consisting of platinum, rhodium, palladium, iridium, silver, gold, and combinations of two or more thereof, more preferably from the group consisting of platinum, rhodium, palladium, and combinations of two or more thereof, and wherein more preferably the composite oxide further comprises palladium.
10. The composite oxide according to embodiment 9, wherein the one or more catalytic metals are contained therein in an amount in the range of from 0.05 to 10 wt.-% based on the total weight of ceria, praseodymia, and alumina in the composite oxide, preferably from 0.1 to 5 wt.-%, more preferably from 0.2 to 2 wt.-%, more preferably from 0.3 to 1 wt.-%, and more preferably from 0.4 to 0.6 wt.-%.
11. The composite oxide according to any of embodiments 1 to 10, wherein the composite oxide is comprised in a catalyst system for exhaust gas treatment, preferably in a three-way catalytic convertor (TWC) or in a diesel oxidation catalyst (DOC).
12. A method of preparing a composite oxide comprising ceria, praseodymia, and alumina, preferably of a composite oxide according to any of embodiments 1 to 11, comprising:
   (a) mixing one or more precursor compounds of ceria, one or more precursor compounds of praseodymia, optionally one or more precursor compounds of zirconia and/or optionally one or more precursor compounds of one or more rare earth oxides other than ceria and praseodymia, one or more precursor compounds of alumina, and one or more basic compounds in a solvent system for obtaining a suspension;
   (b) optionally heating the suspension obtained in step (a);
   (c) optionally adding one or more surfactant compounds to the suspension obtained in step (a) or (b);
   (d) separating the solids from the suspension obtained in step (b) or (c);
   (e) optionally washing the solids obtained in step (d);
   (f) optionally drying the solids obtained in step (d) or (e);
   (g) optionally calcining the solids obtained in step (d), (e), or (f);
wherein the cerium:praseodymium molar ratio of the suspension obtained in step (a) is 84:16 or less, and is preferably comprised in the range of from 15:85 to 80:20, more preferably from 25:75 to 75:25, more preferably from 35:65 to 70:30, more preferably from 40:60 to 65:35, more preferably from 42.5:57.5 to 62.5: 37.5, more preferably from 45:55 to 60:40, more preferably from 47.5:52.5 to 57.5:42.5, more preferably from 50:50 to 55:45.
13. The method according to embodiment 12, wherein the content of cerium in the suspension obtained in (a) is in the range of from 15 to 80 mol.-% based on 100 mol.-% of the total moles of cerium, praseodymium and aluminum in the suspension, preferably from 20 to 75 mol.-%, more preferably from 25 to 70 mol.-%, more preferably from 30 to 65 mol.-%, more preferably from 35 to 60 mol.-%, more preferably from 40 to 55 mol.-%, more preferably from 42.5 to 52.5 mol.-%, more preferably from 45 to 50 mol.-%.
14. The method according to embodiment 12 or 13, wherein the content of praseodymium in the suspension obtained in (a) is in the range of from 15 to 80 mol.-% based on 100 mol.-% of the total moles of cerium, praseodymium and aluminum in the suspension, preferably from 20 to 75 mol.-%, preferably from 25 to 70 mol.-%, more preferably from 30 to 60 mol.-%, more preferably from 32.5 to 55 mol.-%, more preferably from 35 to 50 mol.-%, more preferably from 37.5 to 47.5 mol.-%, more preferably from 40 to 45 mol.-%.
15. The method according to any of embodiments 12 to 14, wherein the content of aluminum in the suspension obtained in (a) is in the range of from 0.2 to 70 mol.-% based on 100 mol.-% of the total moles of cerium, praseodymium and aluminum in the suspension, preferably from 0.5 to 55 mol.-%, more preferably from 1.0 to 45 mol.-%, more preferably from 1.5 to 35 mol.-%, more preferably from 2 to 30 mol.-%, more preferably from 2.5 to 25 mol.-%, more preferably from 3 to 20 mol.-%, more preferably from 3.5 to 15 mol.-%, more preferably from 4 to 12 mol.-%, more preferably from 4.5 to 11 mol.-%, more preferably from 5 to 10 mol.-%.
16. The method according to any of embodiments 12 to 15, wherein the optional one or more precursor compounds of one or more rare earth oxides other than ceria and praseodymia are selected from the group consisting of precursor compounds of lanthana, neodymia, samaria, gadolinia, terbia, yttria and combinations of two or more thereof, wherein preferably the one or more precursor compounds of one or more rare earth oxides other than ceria and praseodymia is selected from the group consisting of precursor compounds of lanthana, neodymia, yttria, and combinations of two or more thereof, wherein more preferably the one or more precursor compounds of one or more rare earth oxides other than ceria and praseodymia comprises yttria and/or neodymia, preferably yttria, and wherein more preferably the one or more precursor compounds of one or more rare earth oxides other than ceria and praseodymia is yttria and/or neodymia, preferably yttria.
17. The method according to any of embodiments 12 to 16, wherein the total content of the optional one or more precursor compounds of zirconia and/or of the optional one or more precursor compounds of one or more rare earth oxides other than ceria and praseodymia in the suspension obtained in (a) is in the range of from 0.2 to 40 mol.-% calculated as the metal element of the respective oxide and based on 100 mol.-% of the total moles of rare earth metals, aluminum, and optional zirconium in the suspension, more preferably from 0.5 to 30 mol.-%, more preferably from 1 to 20 mol.-%, more preferably from 1.5 to 15 mol.-%, more preferably from 2 to 12 mol.-%, more preferably from 2.5 to 10 mol.-%, more preferably from 3 to 8 mol.-%, more preferably from 3.5 to 7 mol.-%, more preferably from 4 to 6 mol.-%, more preferably from 4.5 to 5.5 mol.-%.
18. The method according to any of embodiments embodiment 12 to 17, wherein independently from one another, the one or more precursor compounds of ceria and/or the one or more precursor compounds of praseodymia are salts, preferably selected from the group consisting of sulfates, nitrates, phosphates, chlorides, bromides, acetates, and combinations of two or more thereof, preferably selected from the group consisting of nitrates, chlorides, acetates, and combinations of two or more thereof, and wherein more preferably the one or more precursor compounds of ceria and/or the one or more precursor compounds of praseodymia are nitrates.
19. The method according to any of embodiments 12 to 18, wherein the one or more precursor compounds of alumina are selected from the group consisting of aluminum salts, aluminum oxide hydroxides, aluminum hydroxides, alumina, and combinations of two or more thereof, preferably selected from the group consisting of aluminum sulfates, aluminum nitrates, aluminum phosphates, aluminum chlorides, aluminum bromides, aluminum acetates, diaspore, boehmite, akdalaite, gibbsite, bayerite, doyleite, nordstrandite, and combinations of two or more thereof, more preferably selected from the group consisting of aluminum sulfate, aluminum nitrate, aluminum chloride, diaspore, boehmite, akdalaite, and combinations of two or more thereof, and wherein more preferably the one or more precursor compounds of alumina are aluminum nitrate and/or boehmite, more preferably aluminum nitrate.
20. The method according to any of embodiments 12 to 19, wherein the one or more precursor compounds of alumina are selected from the group consisting of colloidal alumina, colloidal aluminum oxide hydroxides, colloidal aluminum hydroxides, and combinations of two or more thereof, preferably from the group consisting of colloidal diaspore, colloidal boehmite, colloidal akdalaite, colloidal gibbsite, colloidal bayerite, colloidal doyleite, colloidal nordstrandite, and combinations of two or more thereof, more preferably selected from the group consisting of colloidal diaspore, colloidal boehmite, colloidal akdalaite, colloidal gibbsite, colloidal bayerite, colloidal doyleite, colloidal nordstrandite, and combinations of two or more thereof, wherein more preferably the one or more precursor compounds of alumina comprises colloidal boehmite, and wherein more preferably the one or more precursor compounds of alumina is colloidal boehmite.
21. The method according to any of embodiments 12 to 20, wherein the one or more basic compounds in step (a) are selected from the group consisting of alkali metal hydroxides, alkaline earth metal hydroxides, ammonia, alkylammonium hydroxides, and combinations of two or more thereof, preferably from the group consisting of sodium hydroxide, potassium hydroxide, barium hydroxide, ammonia, (C₁-C₆)tetraalkylammonium hydroxides, and combinations of two or more thereof, more preferably from the group consisting of barium hydroxide, ammonia, tetramethylammonium hydroxide, tetraethylammonium hydroxide, tetrapropylammonium hydroxide, tetrabutylammonium hydroxide, and combinations of two or more thereof, and wherein more preferably said one or more basic compounds comprise ammonia, wherein more preferably ammonia is used as the basic compound in step (a).
22. The method according to any of embodiments 12 to 21, wherein in step (a), the one or more precursor compounds of ceria, the one or more precursor compounds of praseodymia, the optional one or more precursor compounds of zirconia, the optional one or more precursor compounds of one or more rare earth oxides other than ceria and praseodymia, and the one or more precursor compounds of alumina are added to the solvent system containing the one or more basic compounds.
23. The method according to embodiment 22, wherein in step (a) independently from one another, the one or more precursor compounds of ceria, the one or more precursor compounds of praseodymia, the optional one or more precursor compounds of zirconia, the optional one or more precursor compounds of one or more rare earth oxides other than ceria and praseodymia, and/or the one or more precursor compounds of alumina are dissolved and/or dispersed in separate solutions and/or in a single solution before being added to the solvent system containing the one or more basic compounds.
24. The method according to embodiment 22 or 23, wherein the one or more precursor compounds of praseodymia, the optional one or more precursor compounds of zirconia, the optional one or more precursor compounds of one or more rare earth oxides other than ceria and praseodymia, and the one or more precursor compounds of alumina are dissolved and/or dispersed in a single solution, wherein preferably said single solution containing the one or more precursor compounds of praseodymia, the optional one or more precursor compounds of zirconia, the optional one or more precursor compounds of one or more rare earth oxides other than ceria and praseodymia, and the one or more precursor compounds of alumina, and a separate solution containing the one or more precursor compounds of ceria are added simultaneously or consecutively, preferably consecutively, into the solvent system containing the one or more basic compounds, wherein more preferably the solution containing the one or more precursor compounds of ceria is added to the solvent system containing the one or more basic compounds prior to the addition of the separate solution containing the one or more precursor compounds of praseodymia, the optional one or more precursor compounds of zirconia, the optional one or more precursor compounds of one or more rare earth oxides other than ceria and praseodymia, and the one or more precursor compounds of alumina to the resulting mixture.
25. The method according to any of embodiments 22 or 23, wherein the one or more precursor compounds of praseodymia, the optional one or more precursor compounds of zirconia, and the optional one or more precursor compounds of one or more rare earth oxides other than ceria and praseodymia are dissolved and/or dispersed in a single solution, and the one or more precursor compounds of alumina are dissolved and/or dispersed in a separate solution, wherein the solution containing the one or more precursor compounds of alumina is added to the solvent system containing the one or more basic compounds prior to the addition of the solution containing the one or more precursor compounds of praseodymia, the optional one or more precursor compounds of zirconia, and the optional one or more precursor compounds of one or more rare earth oxides other than ceria and praseodymia and of a separate solution containing the one or more precursor compounds of ceria, wherein the solution containing the one or more precursor compounds of praseodymia, the optional one or more precursor compounds of zirconia, and the optional one or more precursor compounds of one or more rare earth oxides other than ceria and praseodymia and the separate solution containing the one or more precursor compounds of ceria are added simultaneously or consecutively, preferably consecutively, into the mixture of the one or more precursor compounds of alumina and the one or more basic compounds in the solvent system, wherein more preferably the solution containing the one or more precursor compounds of ceria is added prior to the solution containing the one or more precursor compounds of praseodymia, the optional one or more precursor compounds of zirconia, and the optional one or more precursor compounds of one or more rare earth oxides other than ceria and praseodymia to the resulting mixture of the one or more precursor compounds of ceria, the one or more precursor compounds of alumina, and the one or more basic compounds in the solvent system.
26. The method according to any of embodiments 12 to 25, wherein independently from one another the solvent system in step (a) and the solution or solutions in which the one or more precursor compounds of ceria, the one or more precursor compounds of praseodymia, the optional one or more precursor compounds of zirconia, the optional one or more precursor compounds of one or more rare earth oxides other than ceria and praseodymia, and/or the one or more precursor compounds of alumina are preferably dissolved and/or dispersed comprise one or more solvents selected from the group consisting of alcohols, water, and mixtures of two or more thereof, preferably from the group consisting of (C₁-C₅)alcohols, water, and mixtures of two or more thereof, more preferably from the group consisting of (C₁-C₅)alcohols, water, and mixtures of two or more thereof, more preferably from the group consisting of methanol, ethanol, propanol, water, and mixtures of two or more thereof, wherein more preferably the solvent system and/or said solutions comprise water, wherein more preferably water is the solvent used for the solvent system in step (a) and or for the solution or solutions in which the one or more precursor compounds of ceria, the one or more precursor compounds of praseodymia, the optional one or more precursor compounds of zirconia, the optional one or more precursor compounds of one or more rare earth oxides other than ceria and praseodymia, and/or the one or more precursor compounds of alumina are preferably dissolved and/or dispersed.
27. The method according to any of embodiments 22 to 26, wherein in step (a) the solvent system containing the one or more basic compounds, without the addition of any of the one or more precursor compounds of ceria, the one or more precursor compounds of praseodymia, the optional one or more precursor compounds of zirconia, the optional one or more precursor compounds of one or more rare earth oxides other than ceria and praseodymia, and the one or more precursor compounds of alumina, has a pH in the range of from 10 to 14, preferably from 11 to 13, more preferably from 11.5 to 12.5.
28. The method according to any of embodiments 22 to 27, wherein in step (a) during the addition of the one or more precursor compounds of ceria, the one or more precursor compounds of praseodymia, the optional one or more precursor compounds of zirconia, the optional one or more precursor compounds of one or more rare earth oxides other than ceria and praseodymiato the solvent system containing the one or more basic compounds, the pH of the resulting solution is maintained in the range of from 7 to 14 during the addition of the further precursor compounds, and preferably in the range from 7.5 to 13.5, more preferably from 8 to 13, more preferably from 8.5 to 12.5, and more preferably from 9 to 12.
29. The method according to any of embodiments 12 to 28, wherein the optional heating in step (b) is carried out at a temperature in the range of from 80 to 250° C., preferably in the range of from 100 to 200° C., more preferably from 125 to 175° C., and more preferably from 140 to 160° C.
30. The method according to any of embodiments 12 to 29, wherein the optional heating in step (b) is carried out under autogenous pressure, preferably under solvothermal conditions, more preferably under hydrothermal conditions.
31. The method according to any of embodiments 12 to 30, wherein the duration of the optional heating in step (b) is in the range of from 0.1 to 24 h, preferably from 0.2 to 12 h, more preferably from 0.5 to 6 h, more preferably from 1 to 4 h, and more preferably from 1.5 to 3 h.
32. The method according to any of embodiments 12 to 31, wherein in step (c) the one or more surfactant compounds are preferably selected among organic surfactant compounds, more preferably among ionic and non-ionic organic surfactants, and combinations thereof, and are more preferably selected from the group consisting of anionic organic surfactants, non-ionic organic surfactants, and combinations of two or more thereof, more preferably from the group consisting of polyalkylene glycols, carboxylic acids, carboxylic salts, carboxymethylated fatty alcohol ethoxylates, and combinations of two or more thereof, more preferably from the group consisting of polyethylene glycols, carboxylic acids, carboxylic salts, and combinations of two or more thereof, more preferably from the group consisting of carboxylic acids, carboxylic salts, and combinations of two or more thereof, more preferably from the group consisting of carboxylic acids, and combinations of two or more thereof, more preferably from the group consisting of (C₆-C₁₈)carboxylic acids, and combinations of two or more thereof, more preferably from the group consisting of (C₈-C₁₆)carboxylic acids, and combinations of two or more thereof, more preferably from the group consisting of (C₁₀-C₁₄)carboxylic acids, and combinations of two or more thereof, wherein more preferably said one or more surfactant compounds comprise lauric acid, wherein more preferably lauric acid is used as the surfactant compound in step (c).
33. The method according to any of embodiments 12 to 32, wherein in step (e) the solids are washed with an aqueous solution, more preferably with an aqueous base, and more preferably with aqueous ammonia, wherein the aqueous base and preferably the aqueous ammonia used in step (e) has a pH ranging from 10 to 14, preferably from 11 to 13, and more preferably from 11.5 to 12.5.
34. The method according to any of embodiments 12 to 33, wherein the optional drying of the solids in step (f) is carried out for a duration in the range of from 0.5 h to 2 d, more preferably in the range of from 1 h to 1.5 d, more preferably from 2 h to 1 d, more preferably from 4 to 18 h, more preferably from 6 to 14 h, and more preferably from 8 to 12 h.
35. The method according to any of embodiments 12 to 34, wherein in step (g) the solids are calcined at a temperature in the range of from 200 to 1000° C., more preferably in the range of from 300 to 900° C., more preferably from 400 to 800° C., more preferably from 500 to 700° C., and more preferably from 550 to 650° C.
36. The method according to any of embodiments 12 to 35, wherein in step (g) the duration of calcination is in the range of from 0.1 h to 2 d, preferably from 0.2 h to 1.5 d, more preferably from 0.5 h to 1 d, more preferably from 1 to 12 h, more preferably from 2 to 8 h, more preferably from 3 to 5 h.
37. The method according to any of embodiments 12 to 36, wherein the method further comprises
   (h) impregnating the solids obtained in step (d), (e), (f), or (g) with one or more catalytic metals, preferably by incipient wetness impregnation.
38. The method according to any of embodiments 12 to 37, wherein in step (h) the one or more catalytic metals are selected from the group consisting of transition metals and combinations of two or more thereof, more preferably from the group consisting of platinum, rhodium, palladium, iridium, silver, gold, and combinations of two or more thereof, more preferably from the group consisting of platinum, rhodium, palladium, and combinations of two or more thereof, wherein more preferably the one or more catalytic metals comprise palladium, and wherein more preferably palladium is the catalytic metal impregnated in step (h).
39. The method according to any of embodiments 12 to 38, which further comprises
   (i) drying and/or calcining the solids obtained in step (h); wherein the calcination in step (i) is preferably carried out at a temperature in the range of from 200 to 900° C., more preferably from 300 to 800° C., more preferably from 400 to 700° C., and more preferably from 500 to 600° C.
40. A composite oxide obtained and/or obtainable by a process according to the process of any of embodiments 12 to 39.
41. A process of treating an exhaust gas stream, comprising
   (1) providing an exhaust gas stream;
   (2) contacting the exhaust gas stream of step (1) with a catalyst comprising a composite oxide comprising ceria, praseodymia, and alumina according to any of embodiments 1 to 11, and 40;
   wherein the exhaust gas is preferably from a diesel or gasoline engine, more preferably from a gasoline engine.
42. Use of composite oxide according to any of embodiments 1 to 11, and 40 as a catalyst, catalyst support, or catalyst component, preferably as an oxygen storage component, wherein preferably the composite oxide is used as a catalyst for the oxidation of hydrocarbons and/or carbon monoxide and/or for the conversion of NOₓ, wherein the composite oxide is preferably used in the treatment of exhaust gas.

### DESCRIPTION OF THE FIGURES

FIG. 1 is a graphical representation of the results from lambda-sweep catalyst testing in Example 13 performed on the samples from Examples 1-7 and Comparative Examples 8-11 as contained in Table 4 displayed as a bar chart. In the Figure, the values displayed in the abscissa “X” stand for the average conversion in % of NO (top chart), HC (middle chart), and CO (bottom chart) as obtained for the samples from the respective examples and comparative examples as obtained in the fresh state (light grey bar on the left), after hydrothermal aging for 5 h (grey bar in the middle), and after hydrothermal aging for 20 h (dark grey bar on the right).

FIGS. 2 and 3 respectively display an image of a “fresh” (i.e. after having been subject to calcination at 600° C.) ceria-praseodymia-alumina composite mixed oxide according to the present invention, as obtained from transmission electron microscopy (TEM). In the images, the ceria-praseodymia-alumina composite mixed oxide product and unreacted pradeodymium oxide are respectively designated.

FIGS. 4 and 5 respectively display an image of a hydrothermally aged ceria-praseodymia-alumina composite mixed oxide according to the present invention as obtained from transmission electron microscopy (TEM), wherein the sample has been subject to hydrothermal aging at 1000° C. for 5 hours in air and 10 vol. % of steam. In the images, the ceria-praseodymia-alumina composite mixed oxide product as well as praseodymium aluminum oxide side-product are respectively designated.

### EXAMPLES

Lambda-Sweep Testing

For aging, powder samples were placed as shallow bed in high temperature resistant ceramic crucibles and heated in a muffle furnace. Aging was carried out under a flow of air and 10% steam controlled by a water pump. The temperature was ramped up to a desired value (1000° C.) and remained at the desired temperature for a desired amount of time (5 h or 20 h) before the heating was switched off.

For determining the catalytic activity of the new as well as reference samples, all samples were impregnated with a solution of palladium nitrate for a target loading of 0.5 wt.-% of Pd based on 100 wt.-% of the composite oxide, mixed with 3 wt % boehmite dispersion as binder, dried, and subsequently calcined at 550° C. The resulting cake is crushed and sieved, a size fraction of 250-500 μm is used for testing fresh and after oven aging (1000° C., 5 h or 20 h, 10% steam/air). Tests were performed in a 48-fold parallel testing unit. 100 mg of the respective samples were diluted to a volume of 1 mL using corundum of the same particle size fraction and placed in a reactor.

To assess catalytic performance of the materials in a three way catalytic converter, the response of the samples to a modification of the air to fuel ratio was tested in a A-sweep test at different temperatures. Powder samples prepared as described above were exposed to a gas feed with oscillating composition (1 s lean, 1 s rich) at a GHSV of 70000 h⁻¹ with a defined average A value (ratio of actual and stoichiometric air/fuel ratio). The composition of the gas stream under rich and lean conditions is described in Table 1 below.

TABLE 1
lean and rich gas compositions for lambda-sweep testing

| | Lean | Rich |
|---|---|---|
| CO [vol.-%] | 0.7 | 2.33 |
| H2 [vol.-%] | 0.22 | 0.77 |
| O2 [vol.-%] | 1.8 ± Δ | 0.7 ± Δ |
| HC (Propylene:Propane 2:1) [ppmv C₁] | 3000 | 3000 |
| NO [ppmv] | 1500 | 1500 |
| CO2 [vol.-%] | 14 | 14 |
| H2O [vol.-%] | 10 | 10 |

At stationary temperatures (250, 300, 350, 450° C.), the steady state conversion of CO, NO and HC was measured at 5 discrete average λ values of 1.02, 1.01, 1.00, 0.99, 0.98, adjusted by modifying the amount of oxygen (parameter Δ in the Table 1) without disturbing the amplitude of the rapid oscillations. This simulates to some extent a range of load points of a gasoline engine and probes for good oxygen storage capacity as well as platinum group metal (PGM) activity. For sample ranking, an average conversion over the λ window 1.02-0.98 was calculated for each temperature.

X-ray Diffraction

For X-Ray diffraction (XRD), data were collected on a Bruker AXS D8 C2 Discover. Cu K_{α} radiation was used in the data collection. The beam was narrowed and monochromatized using a graphite monochromator and a pinhole collimator (0.5 mm). Generator settings of 40 kV and 40 mA were used. Samples were gently ground in a mortar with a pestle and then packed in a round mount. The data collection from the round mount covered a 20 range from 16° to 53.5° using a step scan with a step size of 0.02° and a count time of 600s per step. GADDS Analytical X-Ray Diffraction Software was used for all steps of the data analysis. The phases present in each sample were identified by search and match of the data available from Inorganic Crystal Structure Database (ICSD).

Nitrogen Adsorption Measurements

N₂-Adsorption/desorption measurements were carried out on a Micromeritics TriStar II.

Samples were degassed for 30 minutes at 150° C. under a flow of dry nitrogen on a Micromeritics SmartPrep degasser.

### Example 1

### Preparation of a Ceria-Praseodymia-Alumina Composite Mixed Oxide

This example describes the preparation of a composite oxide of cerium, praseodymium and aluminum in the respective molar metal proportions of 50%, 40%, 10%. In a beaker 0.05 mol Ce, applied as (NH₄)₂Ce(NO₃)₆, were dissolved in 150 ml deionized water (DI-water) under stirring (Solution A). A second solution (Solution B) was prepared by dissolving 0.04 mol Pr, applied as Pr(NO₃)₃×6 H₂O, and 0.01 mol Al, applied as Al(NO₃)₃×9H₂O in 50 ml DI-water. Solutions A and B were stirred until all of the applied solids have been dissolved. A precipitation vessel was prepared by diluting NH₃, applied as concentrated ammonia solution (25%), with DI-water. The total volume of the mixture was 200 ml at the end. The mixture of concentrated ammonia in DI-water was found to have a pH value of 12. Solution A and B were added consecutively and drop wise into the precipitation vessel using a flow rate of 10m1/min under constant stirring of the resulting mixture. During the precipitation process the pH value was not allowed to drop below 9. This was controlled by constantly adding additional ammonia solution (25%). The suspension was stirred for 15 minutes before being transferred into an autoclave (50% fill quantity) and stirred for 2h at 150° C. The suspension was allowed to cool to room temperature overnight, before 0.022 mol of lauric acid (LA) (0.22 mol LA per mol of Ce, Pr, and Al employed) was added. The mixture was stirred until total dilution of the lauric acid was achieved. The suspension was filtered with a blue ribbon filter thereafter and washed with ammonia solution (25%) until the filter cake was free of NO₃⁻ ions. The filter cake was dried at 40° C. and subsequently calcined at 600° C. for 4 h using a muffle furnace.

### Example 2

### Preparation of a Ceria-Praseodymia-Alumina Composite Mixed Oxide

This example describes the preparation of a composite oxide of cerium, praseodymium and aluminum in the respective molar metal proportions of 50%, 45%, 5%. The starting materials used in this preparation included 0.05 mol of Ce applied as (NH₄)₂Ce(NO₃)₆ (Solution A), and for solution B 0.045 mol Pr, applied as Pr(NO₃)₃×6 H₂O, and 0.005 mol Al, applied as Al(NO₃)₃×9H₂O. The procedure described in Example 1 was followed.

Example 3: Preparation of a ceria-praseodymia-lanthana-alumina composite mixed oxide

This example describes the preparation of a composite oxide of cerium, praseodymium, aluminum and lanthanum in the respective molar metal proportions of 45%, 45%, 5%, 5%. The starting materials used in this preparation included 0.045 mol of Ce applied as (NH₄)₂Ce(NO₃)₆ (Solution A), and for solution B 0.045 mol Pr, applied as Pr(NO₃)₃×6 H₂O, 0.005 mol Al applied as Al(NO₃)₃×9H₂O and 0.005 mol La applied as La(NO₃)₃×H₂O. The procedure described in Example 1 was followed, wherein lanthanum was added as a part of Solution B.

### Example 4

### Preparation of a Ceria-Praseodymia-Yttria-Alumina Composite Mixed Oxide

This example describes the preparation of a composite oxide of cerium, praseodymium, aluminum and yttrium in the respective molar metal proportions of 45%, 45%, 5%, 5%. The starting materials used in this preparation included 0.045 mol of Ce applied as (NH₄)₂Ce(NO₃)₆ (Solution A), and for solution B 0.045 mol Pr, applied as Pr(NO₃)₃×6 H₂O, 0.005 mol Al applied as Al(NO₃)₃×9H₂O and 0.005 mol Y applied as Y(NO₃)₃×6 H₂O. The procedure described in Example 1 was followed, wherein yttrium was added as a part of Solution B.

### Example 5

### Preparation of a Ceria-Praseodymia-Neodymia-Alumina Composite Mixed Oxide

This example describes the preparation of a composite oxide of cerium, praseodymium, aluminum and neodymium in the respective molar metal proportions of 45%, 45%, 5%, 5%. The starting materials used in this preparation included 0.045 mol of Ce applied as (NH₄)₂Ce(NO₃)₆ (Solution A), and for solution B 0.045 mol Pr, applied as Pr(NO₃)₃×6 H₂O, 0.005 mol Al applied as Al(NO₃)₃×9H₂O and 0.005 mol Nd applied as Nd(NO₃)₃×6 H₂O. The procedure described in Example 1 was followed, wherein neodymium was added as a part of Solution B.

### Example 6

### Preparation of a Ceria-Praseodymia-Lanthana-Yttria-Alumina Composite Mixed Oxide

This example describes the preparation of a composite oxide of cerium, praseodymium, aluminum, lanthanum and yttrium in the respective molar metal proportions of 45%, 40%, 5%, 5%, 5%. The starting materials used in this preparation included 0.045 mol of Ce applied as (NH₄)₂Ce(NO₃)₆ (Solution A), and for solution B 0.040 mol Pr, applied as Pr(NO₃)₃×6 H₂O, 0.005 mol Al applied as Al(NO₃)₃×9H₂O, 0.005 mol La applied as La(NO₃)₃×H₂O and 0.005 mol Y applied as Y(NO₃)₃'6 H₂O. The procedure described in Example 1 was followed, wherein yttrium and lanthanum were added as a part of Solution B.

### Example 7

### Preparation of a Ceria-Praseodymia Composite Mixed Oxide

This example describes the preparation of a composite oxide of cerium, praseodymium and aluminum in the respective molar metal proportions of 50%, 40%, 10%. In a beaker 0.05 mol Ce, applied as (NH₄)₂Ce(NO₃)₆, were dissolved in 150 ml deionized water (DI-water) under stirring (Solution A). Solution B was prepared by dissolving 0.04 mol Pr, applied as Pr(NO₃)₃×6 H₂O in 50 ml DI-water. Solutions A and B were stirred until all of the applied solids have been dissolved. A precipitation vessel was prepared by diluting NH₃, applied as concentrated ammonia solution (25%), with DI-water. The total volume of the mixture was 400 ml at the end. The mixture of concentrated ammonia in DI-water was found to have a pH value of 12. Under constant stirring 0.01 mol aluminum was added, using a colloidal aqueous suspension of alumina (particle size ˜200 nm) as aluminum source. Solution A and B were added consecutively and drop wise into the suspension in the precipitation vessel using a flow rate of 10 ml/min under constant stirring of the mixture. During the precipitation process the pH value was not allowed to drop below 9. This was controlled by constantly adding of additional ammonia solution (25)%. The suspension was stirred for 15 minutes before being transferred into an autoclave (50% fill quantity) and stirred for 2 h at 150° C. The suspension was allowed to cool to room temperature overnight, before 0.022 mol of lauric acid (LA) (0.22 mol LA per mol of Ce, Pr, and Al employed) was added. The mixture was stirred until total dilution of the lauric acid was achieved. The suspension was filtered with a blue ribbon filter thereafter and washed with ammonia solution (25%) until the filter cake was free of NO3⁻ ions. The filter cake was dried at 40° C. and subsequently calcined at 600° C. for 4 h using a muffle furnace.

### Comparative Example 8

### Preparation of a Ceria

This example describes the preparation of cerium oxide. The starting material used in this preparation included 0.1 mol of Ce applied as (NH₄)₂Ce(NO₃)₆. The procedure described in Example 1 was followed. No solution B was prepared.

### Comparative Example 9

### Preparation of a Ceria-Praseodymia Mixed Oxide

This example describes the preparation of a composite oxide of cerium and praseodymium, in the respective molar metal proportions of 50%, 50%. The starting materials used in this preparation included 0.05 mol of Ce applied as (NH₄)₂Ce(NO₃)₆ and 0.05 mol Pr, applied as Pr(NO₃)₃×6 H₂O. The procedure described in Example 1 was followed. No aluminum was added to Solution B.

### Comparative Example 10

### Preparation of a Ceria-Praseodymia Mixed Oxide

This example describes the preparation of a composite oxide of cerium and praseodymium in the respective molar metal proportions of 50%, 50%. In a beaker 0.05 mol Ce, applied as (NH₄)₂Ce(NO₃)₆ and 0.05 mol Pr, applied as Pr(NO₃)₃×6 H₂O, were dissolved in 300 ml deionized water (DI-water) under stirring (Solution A). The further procedure described in Example 1 was followed. No solution B was prepared.

### Comparative Example 11

### Preparation of a Ceria-Zirconia Mixed Oxide

This example describes the preparation of a composite oxide of cerium and zirconium in the respective molar metal proportions of 50%, 50%. In a beaker 0.05 mol Ce, applied as (NH₄)₂Ce(NO₃)₆ and 0.05 mol Zr, applied as ZrO(NO₃)₂×H₂O (Zr content was determined gravimetrically prior to use), were dissolved in 300 ml deionized water (DI-water) under stirring to form Solution A. The further procedure described in Example 1 was followed. No solution B was prepared.

The compositions of Examples 1-7 and Comparative Examples 8-11 are summarized in Table 2. The numbers represent molar contents (in %) of respective composite oxide constituents normalized to 100%.

TABLE 2
Composition of samples from Examples 1-7 and Comparative
Examples 8-11.

| | Composition, mol. % | | | | | | |
|---|---|---|---|---|---|---|---|
| Sample | CeO₂ | ZrO₂ | LaO_{1,5} | YO_{1,5} | NdO_{1,5} | PrO_{1,83} | AlO_{1,5} |
| EXAMPLE | 50 | — | — | — | — | 40 | 10 |
| 1 | | | | | | | |
| EXAMPLE | 50 | — | — | — | — | 45 | 5 |
| 2 | | | | | | | |
| EXAMPLE | 45 | — | 5 | — | — | 45 | 5 |
| 3 | | | | | | | |
| EXAMPLE | 45 | — | — | 5 | — | 45 | 5 |
| 4 | | | | | | | |
| EXAMPLE | 45 | — | — | — | 5 | 45 | 5 |
| 5 | | | | | | | |
| EXAMPLE | 45 | — | 5 | 5 | — | 40 | 5 |
| 6 | | | | | | | |
| EXAMPLE | 50 | — | — | — | — | 40 | 10 |
| 7 | | | | | | | |
| COMP. EX. | 100 | — | — | — | — | — | — |
| 8 | | | | | | | |
| COMP. EX. | 50 | — | — | — | — | 50 | — |
| 9 | | | | | | | |
| COMP. EX. | 50 | — | — | — | — | 50 | — |
| 10 | | | | | | | |
| COMP. EX. | 50 | 50 | — | — | — | — | — |
| 11 | | | | | | | |

### Example 12

### Surface Area Ddetermination (BET)

Table 3 provides data on the BET surface area determined by the standard N₂-adsorption/desorption method. The samples were analyzed fresh, meaning after calcination at 600° C., as well as after being aged at 1000° C. for 5 hours in air and 10 vol. of steam. The data (rounded to full numbers) are discussed in the following. Examples 1-7 exhibit a surface area equal or higher than 80 m²/g before and a surface area equal or higher 10 m²/g after aging. Comparative examples 8 to 10 have surface areas below 73 m²/g fresh and below 10 m²/g after aging. Comparative example 11 has a surface area of 62 m²/g before and 29 m²/g after aging. Thus, it has surprisingly been found that the relatively large surface area of the fresh samples according to the present invention is contributed by the content of alumina in the formulation. After aging, the samples containing alumina quite unexpectedly still show higher surface areas than samples prepared from Ce and Pr or Ce only (Examples 8 to 10). However the surface area after aging is lower than those measured for the comparative sample 11 made from Ce and Zr. The data reveal that the addition Al of to the formulation results in notably higher surface areas in the fresh state and to an overall higher thermal stability compared to samples prepared from Ce and Pr only.

TABLE 3
BET surface area of the samples from Examples 1-7 and Comparative
Examples 8-11 fresh and after hydrothermal aging

BET Surface Area, m²/g

| Sample | Fresh | 1000° C., 5 hrs^{a} |
|---|---|---|
| EXAMPLE 1 | 88 | 11 |
| EXAMPLE 2 | 80 | 10 |
| EXAMPLE 3 | 90 | 10 |
| EXAMPLE 4 | 81 | 10 |
| EXAMPLE 5 | 84 | 10 |
| EXAMPLE 6 | 91 | 11 |
| EXAMPLE 7 | 106 | 11 |
| COMP. EX. 8 | 54 | 3 |
| COMP. EX. 9 | 51 | 8 |
| COMP. EX. 10 | 72 | 2 |
| COMP. EX. 11 | 62 | 29 |

^{a}Hydrothermal aging conditions: 1000° C. for 5 hours in air and 10 vol. % of steam.

### Example 13

### Lambda-Sweep Catalyst Testing

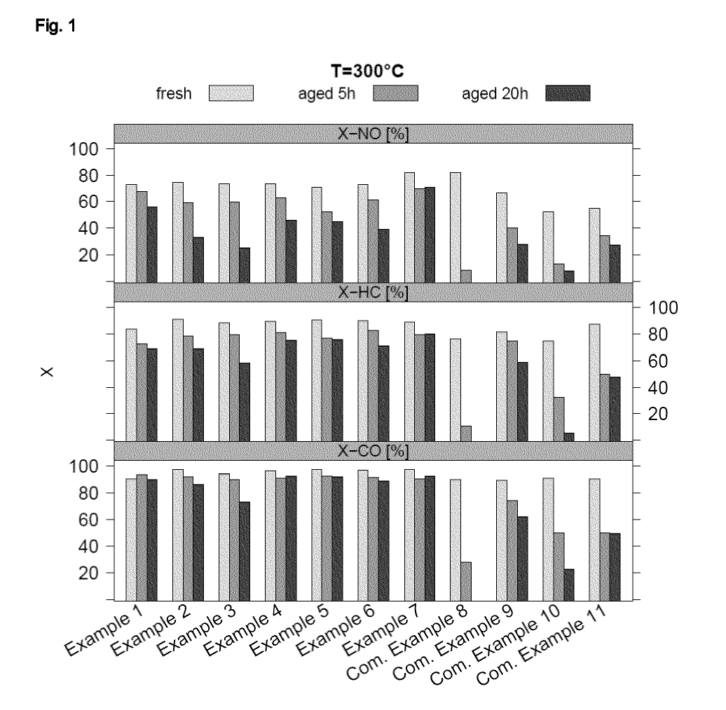

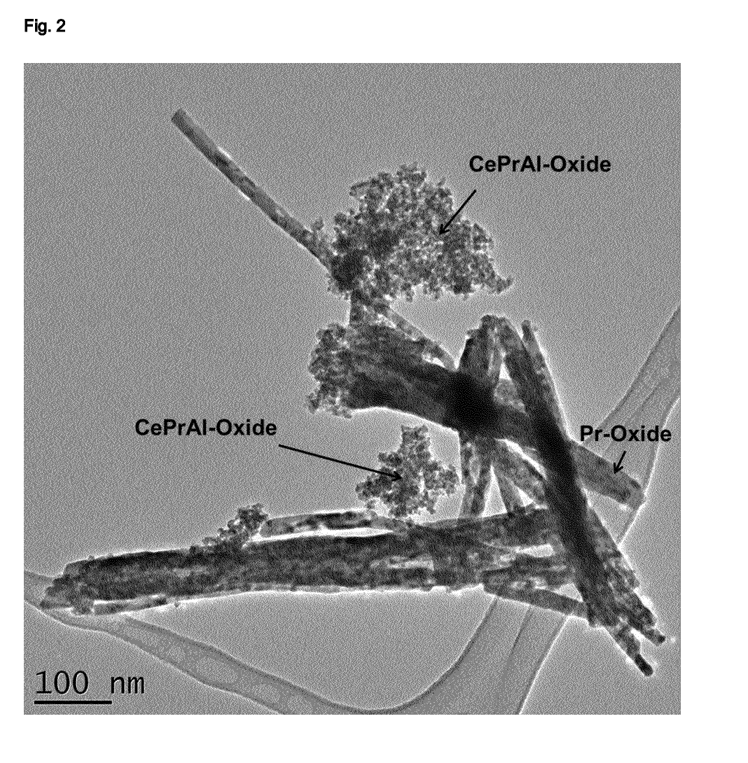

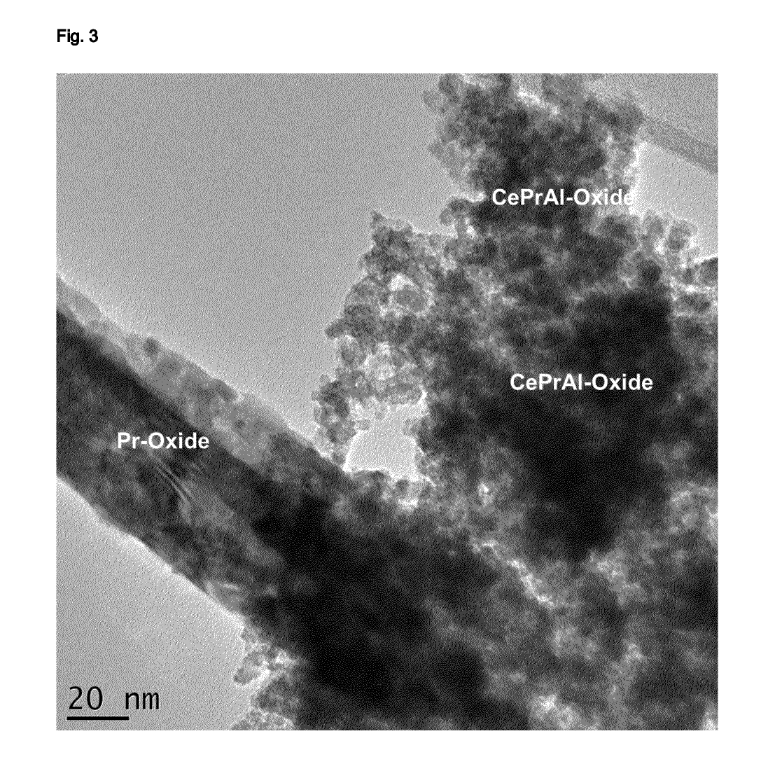

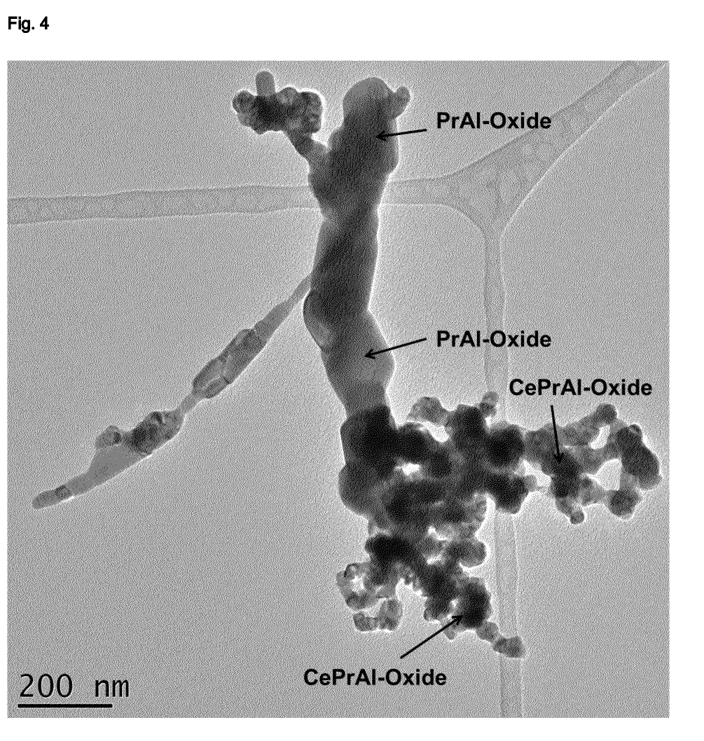

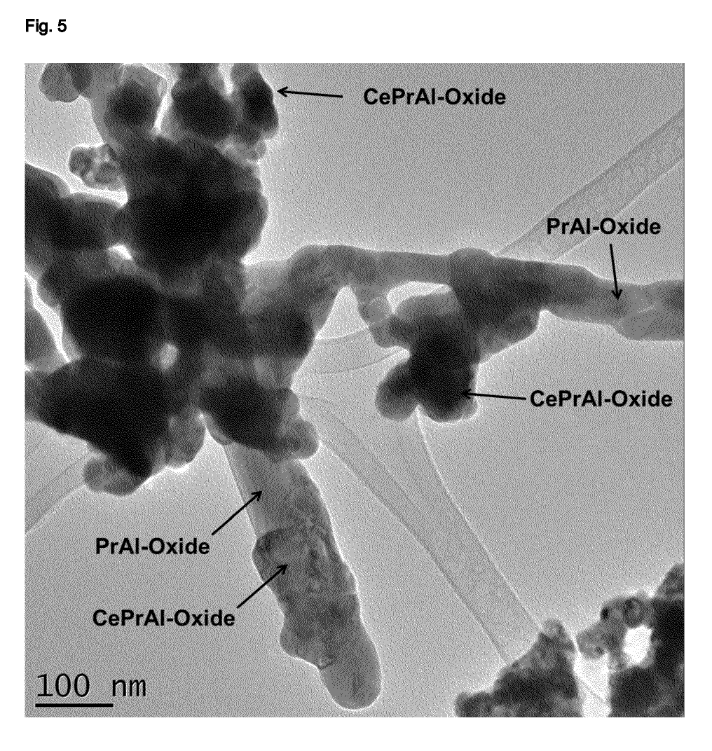

Table 4 shows catalytic data obtained from lambda-sweep testing in the catalytic experiment as described further above. A graphical representation of the result displayed in Table 4 is provided in FIG. 1. Thus, the A-sweep data at 300° C. reveals equivalent fresh performance relative to the comparative examples. However, after aging at 1000° C., examples 1-7 surprisingly show significantly superior conversions since they are less affected by hydrothermal aging, i.e. the comparative examples loose a large fraction of the fresh activity while the examples 1-7 show slower deterioration.

TABLE 4
Results from lambda-sweep catalyst testing performed on the samples from
Examples 1-7 and Comparative Examples 8-11.

| | Average conversion [%] in a λ-window 0.98-1.02 at 300° C. | | | | | | | | |
|---|---|---|---|---|---|---|---|---|---|
| | | | | Aged (1000° C.) | | | Aged (1000° C.) | | |
| | Fresh | | | H₂O/air 5 hrs | | | H₂O/air 20 hrs | | |
| Sample | X-CO | X-HC | X-NO | X-CO | X-HC | X-NO | X-CO | X-HC | X-NO |
| EXAMPLE 1 | 90.8 | 83.8 | 72.9 | 94.1 | 72.5 | 67.4 | 90.2 | 68.9 | 56.1 |
| EXAMPLE 2 | 97.6 | 90.9 | 74.3 | 92.1 | 78.1 | 59.2 | 86.3 | 68.7 | 33.2 |
| EXAMPLE 3 | 94.6 | 88.5 | 73.3 | 90.3 | 79.3 | 59.5 | 73.2 | 58.4 | 25.4 |
| EXAMPLE 4 | 96.6 | 89.6 | 73.4 | 91.5 | 81.2 | 62.9 | 92.6 | 75.1 | 46.2 |
| EXAMPLE 5 | 97.7 | 90.4 | 71.0 | 93.0 | 76.8 | 52.2 | 92.3 | 75.9 | 44.9 |
| EXAMPLE 6 | 97.0 | 90.2 | 72.7 | 92.0 | 82.6 | 61.3 | 89.2 | 71.1 | 38.9 |
| EXAMPLE 7 | 97.4 | 88.9 | 81.7 | 90.8 | 79.3 | 69.7 | 92.8 | 79.7 | 70.8 |
| COMP. EX. 8 | 90.3 | 76.5 | 81.9 | 27.7 | 10.6 | 8.7 | — | — | — |
| COMP. EX. 9 | 89.8 | 81.7 | 66.6 | 74.2 | 74.6 | 40.2 | 62.2 | 59.0 | 27.8 |
| COMP. EX. 10 | 91.1 | 74.8 | 52.2 | 50.0 | 32.4 | 13.1 | 22.6 | 5.4 | 7.7 |
| COMP. EX. 11 | 90.6 | 87.5 | 55.2 | 50.0 | 49.6 | 34.2 | 49.3 | 47.8 | 27.6 |

These results are particularly unexpected relative to the performance of the ceria-zirconia mixed oxide catalyst according to comparative example which, as observed in the determination of the BET surface area (cf. Table 3), appeared to display a greater resistance to hydrothermal aging not only with respect to the other comparative examples devoid of zirconia, but also with respect to the inventive examples. Accordingly, it has quite unexpectedly been found that despite the better stabilization of the ceria-containing oxygen storage material with the aid of zirconia as practiced in the art, the inventive composite materials containing praseodymia in addition to alumina display superior results in the conversion of CO, HC, and NO in exhaust gas not only in a fresh state, but quite surprisingly clearly outperform such oxygen storage materials according to the art after prolonged periods of aging, as evidenced by the results from the lamda-sweep catalyst testing results displayed in Table 4.

Thus it has quite surprisingly been found that the specific catalyst composites of the present invention containing a ceria-paraseodymia mixed oxide in addition to alumina displays superior catalytic results in the treatment of automotive exhaust gas compared to oxygen storage materials according to the art.

1. A composite oxide, comprising:
ceria, praseodymia, and alumina,
wherein the cerium:praseodymium molar ratio of the composite oxide is 84:16 or less.

2. The composite oxide according to claim 1, wherein the content of aluminum is in the range of from 0.2 to 70 mol.-% based on 100 mol.-% of the total moles of cerium, praseodymium and aluminum in the composite oxide.

3. The composite oxide according to claim 1, wherein the alumina is dispersed in the solid solution of ceria and praseodymia.

4. The composite oxide according to claim 1, wherein the composite oxide displays a BET surface area determined according to DIN-ISO 9277 in the range of from 15 to 300 m²/g after aging at 950° C. for 12 h in air containing 10 vol -% of steam.

5. The composite oxide according to claim 1 which further comprises one or more catalytic metals.

6. The composite oxide according to claim 1 wherein the composite oxide is comprised in a catalyst system for exhaust gas treatment.

7. A method of preparing a composite oxide comprising ceria, praseodymia, and alumina, comprising:
(a) mixing one or more precursor compounds of ceria, one or more precursor compounds of praseodymia, optionally one or more precursor compounds of zirconia and/or optionally one or more precursor compounds of one or more rare earth oxides other than ceria and praseodymia, one or more precursor compounds of alumina, and one or more basic compounds in a solvent system for obtaining a suspension;
(b) optionally heating the suspension obtained in step (a);
(c) optionally adding one or more surfactant compounds to the suspension obtained in step (a) or (b);
(d) separating the solids from the suspension obtained in step (b) or (c);
(e) optionally washing the solids obtained in step (d);
(f) optionally drying the solids obtained in step (d) or (e);
(g) optionally calcining the solids obtained in step (d), (e), or (f);
wherein the cerium:praseodymium molar ratio of the suspension obtained in step (a) is 84:16 or less.

8. The method according to claim 7, wherein the content of aluminum in the suspension obtained in (a) is in the range of from 0.2 to 70 mol.-% based on 100 mol.-% of the total moles of cerium, praseodymium and aluminum in the suspension.

9. The method according to claim 7, wherein the one or more precursor compounds of alumina are selected from the group consisting of colloidal alumina, colloidal aluminum oxide hydroxides, colloidal aluminum hydroxides, and combinations of two or more thereof.

10. The method according to claim 7, wherein the optional heating in step (b) is carried out at a temperature in the range of from 80 to 250° C.

11. The method according to claim 7, wherein the optional heating in step (b) is carried out under autogenous pressure.

12. The method according to claim 7, wherein the method further comprises
(h) impregnating the solids obtained in step (d), (e), (f), or (g) with one or more catalytic metals.

13. A composite oxide obtained and/or obtainable by a process according to claim 7.

14. A process of treating an exhaust gas stream, comprising:
(1) providing an exhaust gas stream;
(2) contacting the exhaust gas stream of (1) with a catalyst comprising a composite oxide comprising ceria, praseodymia, and alumina according to claim 1.

15. A catalyst, catalyst support, or catalyst component, comprising:
the composite oxide according to claim 1.
